(19) United States
(12) Patent Application Publication
(10) Pub. No.: US 2003/0139504 A1
(43) Pub. Date: Jul. 24, 2003

(54) Flame retardant resinous compositions and method

(75) Inventors: Thomas Miebach, Clifton Park, NY (US); John Robert Campbell, Clifton Park, NY (US); Monica Marugan, Bergen op Zoom (NL); Thomas Arnold Ebeling, Evansville, IN (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 10/015,049

(22) Filed: Nov. 12, 2001

(51) Int. Cl. C08K 5/24; C08K 3/38; C08K 5/54

(52) U.S. Cl. 524/261; 524/404; 524/405

(57) ABSTRACT

Disclosed are flame retardant resinous compositions comprising (i) at least one aromatic polycarbonate, (ii) at least one silicone source, (iii) at least one boron source, and (iv) optionally at least one member selected from the group consisting of an antidrip agent, a second thermoplastic resin which is not a polycarbonate resin, and a rubber modified graft copolymer. Also disclosed are methods for making said compositions.

### BACKGROUND OF THE INVENTION

The present invention is related to flame retardant resinous compositions comprising at least one aromatic polycarbonate resin, at least one silicone source, at least one boron source, and optionally at least one member selected from the group consisting of an antidrip agent, a second thermoplastic resin which is not a polycarbonate resin, and a rubber modified graft copolymer. In the literature different methods for improving the flame resistance of compositions comprising aromatic polycarbonate resins are described. Typically the methods use either halogenated flame retardants which are said to create potential environmental hazards or phosphate flame retardants which negatively affect the physical properties of the blends, for example by lowering the heat resistance properties. A method is needed for eliminating or reducing the amount of halogenated or phosphate flame retardants in aromatic polycarbonate-comprising compositions which results in good flame resistance without deterioration in other desirable properties. Shaw in commonly owned U.S. Pat. No. 5,714,550 has disclosed flame retardant polyamide-polyphenylene ether compositions which comprise various types of polymeric siloxane compound and at least one boron compound. There remains a need for developing flame retardant systems applicable to compositions comprising a polycarbonate.

### SUMMARY OF THE INVENTION

The present inventors have discovered flame retardant resinous compositions comprising (i) at least one aromatic polycarbonate, (ii) at least one silicone source, (iii) at least one boron source, and (iv) optionally at least one member selected from the group consisting of an antidrip agent, a second thermoplastic resin which is not a polycarbonate resin, and a rubber modified graft copolymer. Also disclosed are methods for making said compositions. Various other features, aspects, and advantages of the present invention will become more apparent with reference to the following description and appended claims.

### BRIEF DESCRIPTION OF THE DRAWINGS

FIG. 1 shows pyrolysis mass spectroscopic data for the composition of Example 51.

FIG. 2 shows pyrolysis mass spectroscopic data for the composition of Example 53.

FIG. 3 is a graph of FOT2 versus the boron oxide level in the compositions of Examples 51-53 and CEx. 51.

### DETAILED DESCRIPTION

The flame retardant resinous compositions of the present invention comprise at least one aromatic polycarbonate resin. Aromatic polycarbonate resins suitable for use in the present invention comprise structural units derived from at least one dihydric phenol and a carbonate precursor. Suitable dihydric phenols include those represented by the formula (I):

HO-D-OH (I)

wherein D comprises a divalent aromatic radical. In various embodiments D has the structure of formula (II);

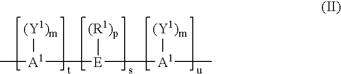

wherein A¹ represents an aromatic group such as phenylene, biphenylene, naphthylene, etc. In some embodiments E may be an alkylene or alkylidene group including, but not limited to, methylene, ethylene, ethylidene, propylene, propylidene, isopropylidene, butylene, butylidene, isobutylidene, amylene, amylidene, isoamylidene. When E is an alkylene or alkylidene group, it may also consist of two or more alkylene or alkylidene groups connected by a moiety different from alkylene or alkylidene, such as an aromatic linkage; a tertiary amino linkage; an ether linkage; a carbonyl linkage; a silicon-containing linkage; or a sulfur-containing linkage including, but not limited to, sulfide, sulfoxide, sulfone; or a phosphorus-containing linkage including, but not limited to, phosphinyl, phosphonyl. In other embodiments E may be a cycloaliphatic group including, but not limited to, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; a sulfur-containing linkage, such as sulfide, sulfoxide or sulfone; a phosphorus-containing linkage, such as phosphinyl or phosphonyl; an ether linkage; a carbonyl group; a tertiary nitrogen group; or a silicon-containing linkage such as silane or siloxy. R¹ represents hydrogen or a monovalent hydrocarbon group such as alkyl, aryl, aralkyl, alkaryl, or cycloalkyl. In various embodiments a monovalent hydrocarbon group of R¹ may be halogen-substituted, particularly fluoro- or chloro-substituted, for example as in dichloroalkylidene. Y¹ may be an inorganic atom including, but not limited to, halogen (fluorine, bromine, chlorine, iodine); an inorganic group including, but not limited to, nitro; an organic group including, but not limited to, a monovalent hydrocarbon group such as alkyl, aryl, aralkyl, alkaryl, or cycloalkyl, or an oxy group such as OR², wherein R² is a monovalent hydrocarbon group such as alkyl, aryl, aralkyl, alkaryl, or cycloalkyl; it being only necessary that Y¹ be inert to and unaffected by the reactants and reaction conditions used to prepare a polycarbonate. In some particular embodiments Y¹ comprises a halo group or C₁-C₆ alkyl group. The letter “m” represents any integer from and including zero through the number of positions on A¹ available for substitution; “p” represents an integer from and including zero through the number of positions on E available for substitution; “t” represents an integer equal to at least one; “s” is either zero or one; and “u” represents any integer including zero.

When more than one Y1 substituent is present as represented by formula (II) above, they may be the same or different. When more than one R1 substituent is present, they may be the same or different. Where “s” is zero in formula (II) and “u” is not zero, the aromatic rings are directly joined with no intervening alkylidene or other bridge. The positions of the hydroxyl groups and Y1 on the aromatic residues A1 can be varied in the ortho, meta, or para positions and the groupings can be in vicinal, asymmetrical or symmetrical relationship, where two or more ring carbon atoms of the aromatic residue are substituted with Y1 and hydroxyl groups.

Some illustrative, non-limiting examples of dihydric phenols of formula (I) include the dihydroxy-substituted aromatic hydrocarbons disclosed by name or formula (generic or specific) in U.S. Pat. No. 4,217,438. In some embodiments of the invention dihydric phenols include 6-hydroxy-1-(4′-hydroxyphenyl)-1,3,3-trimethylindane, 4,4′-(3,3,5-trimethylcyclohexylidene)diphenol; 1,1-bis(4-hydroxy-3-methylphenyl)cyclohexane; 2,2-bis(4-hydroxyphenyl)propane (commonly known as bisphenol-A); 4,4-bis(4-hydroxyphenyl)heptane; 2,2-bis(4-hydroxy-3,5-dimethylphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,4′-dihydroxydiphenylmethane; bis(2-hydroxyphenyl)methane; bis(4-hydroxy-phenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(3-phenyl-4-hydroxyphenyl)-propane; bis(4-hydroxyphenyl)cyclohexylmethane; 2,2-bis(4-hydroxyphenyl)-1-phenylpropane; 3,5,3′,5′-tetrachloro-4,4′-dihydroxyphenyl)propane; 2,4′-dihydroxyphenyl sulfone; 2,6-dihydroxy naphthalene; 6,6′-dihydroxy-3,3,3′,3′-tetramethyl-1,1′-spirobiindane (sometimes know as “SBI”); hydroquinone, resorcinol; C₁₋₃ alkyl-substituted resorcinols. In a particular embodiment the dihydric phenol comprises bisphenol A.

Suitable dihydric phenols also include those containing indane structural units such as represented by the formula (III), which compound is 3-(4-hydroxyphenyl)-1,1,3-trimethylindan-5-ol, and by the formula (IV), which compound is 1-(4-hydroxyphenyl)-1,3,3-trimethylindan-5-ol:

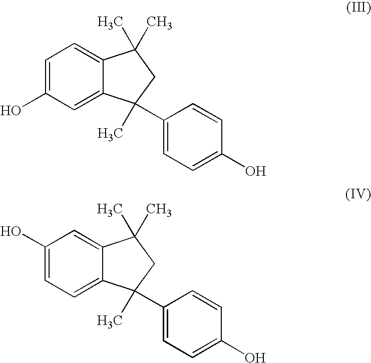

In various embodiments the carbonate precursor for preparing polycarbonates include at least one carbonyl halide, carbonate ester or haloformate. The carbonyl halides which can be employed herein are carbonyl chloride, carbonyl bromide and mixtures thereof. Typical carbonate esters which may be employed herein include, but are not limited to, diaryl carbonates, including, but not limited to, diphenylcarbonate, di(halophenyl)carbonates, di(chlorophenyl)carbonate, di(bromophenyl)carbonate, di(trichlorophenyl)carbonate, di(tribromophenyl)carbonate; di(alkylphenyl)carbonates, di(tolyl)carbonate; di(naphthyl)carbonate, di(chloronaphthyl)carbonate, phenyl tolyl carbonate, chlorophenyl chloronaphthyl carbonate, di(methyl salicyl)carbonate, and mixtures thereof. The haloformates suitable for use herein include bishaloformates of dihydric phenols, which include, but are not limited to, bischloroformates of hydroquinone; bisphenol-A; 3-(4-hydroxyphenyl)-1,1,3-trimethylindan-5-ol; 1-(4-hydroxyphenyl)-1,3,3-trimethylindan-5-ol; 4,4′-(3,3,5-trimethylcyclo-hexylidene)diphenol; 1,1-bis(4-hydroxy-3-methylphenyl)cyclohexane, and the like; bischloroformate-terminated polycarbonate oligomers such as oligomers comprising hydroquinone, bisphenol-A, 3-(4-hydroxyphenyl)-1,1,3-trimethylindan-5-ol; 1-(4-hydroxyphenyl)-1,3,3-trimethylindan-5-ol; 4,4′-(3,3,5-trimethylcyclo-hexylidene)diphenol, 1,1-bis(4-hydroxy-3-methylphenyl)cyclohexane, or the like; and bishaloformates of glycols including, but not limited to, bishaloformates of ethylene glycol, neopentyl glycol, and polyethylene glycol. Mixtures of haloformates may be employed. In a particular embodiment carbonyl chloride, also known as phosgene, is employed. In another particular embodiment diphenylcarbonate is employed. Polycarbonate resins are made by known methods, such as, for example, interfacial polymerization, transesterification, solution polymerization or melt polymerization.

Suitable aromatic polycarbonate resins include linear aromatic polycarbonate resins and branched aromatic polycarbonate resins. Suitable linear aromatic polycarbonates resins include, for example, bisphenol A polycarbonate resin. Suitable branched polycarbonates are known and are made in various embodiments by reacting a polyfunctional aromatic compound with a dihydric phenol and a carbonate precursor to form a branched polymer, see generally, U.S. Pat. Nos. 3,544,514, 3,635,895 and 4,001,184. The polyfunctional compounds are generally aromatic and contain at least three functional groups which are carboxyl, carboxylic anhydrides, phenols, haloformates or mixtures thereof, such as, for example, 1,1,1-tri(4-hydroxyphenyl)ethane, 1,3,5,-trihydroxy-benzene, trimellitic anhydride, trimellitic acid, trimellityl trichloride, 4-chloroformyl phthalic anhydride, pyromellitic acid, pyromellitic dianhydride, mellitic acid, mellitic anhydride, trimesic acid, benzophenonetetracarboxylic acid, benzophenonetetracarboxylic dianhydride. In some particular embodiments polyfunctional aromatic compounds are 1,1,1-tri(4-hydroxyphenyl)ethane, trimellitic anhydride or trimellitic acid or their haloformate derivatives.

In a particular embodiment the polycarbonate resin component of the present invention is a linear polycarbonate resin derived from bisphenol A and phosgene. In some particular embodiments the weight average molecular weight of the polycarbonate resin is in one embodiment from about 10,000 to about 200,000 grams per mole (“g/mol”), in another embodiment from about 20,000 to about 100,000 g/mol, in another embodiment from about 30,000 to about 80,000 g/mol, in another embodiment from about 40,000 to about 60,000 g/mol, and in still another embodiment from about 40,000 to about 50,000 g/mol, all as determined by gel permeation chromatography relative to polystyrene standards. Such resins exhibit an intrinsic viscosity in one embodiment of about 0.1 to about 1.5 deciliters per gram, in another embodiment of about 0.35 to about 0.9 deciliters per gram, in another embodiment of about 0.4 to about 0.6 deciliters per gram, and in still another embodiment of about 0.48 to about 0.54 deciliters per gram, all measured in methylene chloride at 25° C.

In a polycarbonate-containing blend there may an improvement in melt flow and/or other physical properties when one molecular weight grade of a polycarbonate is combined with a proportion of a relatively lower molecular weight grade of similar polycarbonate. Therefore, the present invention encompasses compositions comprising only one molecular weight grade of a polycarbonate and also compositions comprising two or more molecular weight grades of polycarbonate. When two or more molecular weight grades of polycarbonate are present, then the weight average molecular weight of the lowest molecular weight polycarbonate is in one embodiment about 10% to about 95%, in another embodiment about 40% to about 85%, and in still another embodiment about 60% to about 80% of the weight average molecular weight of the highest molecular weight polycarbonate. In one representative, non-limiting embodiment polycarbonate-containing blends include those comprising a polycarbonate with weight average molecular weight between about 40,000 and about 48,000 combined with a polycarbonate with weight average molecular weight between about 25,000 and about 35,000 (in all cases relative to polystyrene standards). When two or more molecular weight grades of polycarbonate are present, the weight ratios of the various molecular weight grades may range from about 1 to about 99 parts of one molecular weight grade and from about 99 to about 1 parts of any other molecular weight grades. In some embodiments a mixture of two molecular weight grades polycarbonate is employed, in which case the weight ratios of the two grades may range in one embodiment from about 99:1 to about 1:99, in another embodiment from about 80:20 to about 20:80, and in still another embodiment from about 70:30 to about 50:50. Since not all manufacturing processes for making a polycarbonate are capable of making all molecular weight grades of that constituent, the present invention encompasses compositions comprising two or more molecular weight grades of polycarbonate in which each polycarbonate is made by a different manufacturing process. In one particular embodiment the instant invention encompasses compositions comprising a polycarbonate made by an interfacial process in combination with a polycarbonate of different weight average molecular weight made by a melt process.

The amount of polycarbonate present in the compositions of the present invention is in one embodiment in a range of between about 55 wt % and about 98 wt %, and in another embodiment in a range of between about 60 wt % and about 95 wt %, based on the weight of the entire composition.

The flame retardant resinous compositions of the present invention may optionally comprise at least one of a second thermoplastic resin, which is not a polycarbonate resin and which forms a second phase in the polycarbonate-comprising composition. The second thermoplastic resin comprises one or more thermoplastic polymers, and exhibits a glass transition temperature (T_{g}) in one embodiment of greater than about 25° C., in another embodiment of greater than or equal to about 90° C. and in still another embodiment of greater than or equal to about 100° C. As referred to herein, the T_{g} of a polymer is the T_{g} value as measured by differential scanning calorimetry (heating rate 20° C./minute, with the T_{g} value being determined at the inflection point). In a particular embodiment the second thermoplastic resin comprises one or more polymers each having structural units derived from one or more monomers selected from the group consisting of vinyl aromatic monomers, monoethylenically unsaturated nitrile monomers, and C₁-C₁₂ alkyl (meth)acrylate monomers.

Suitable vinyl aromatic monomers comprise, e.g., styrene and substituted styrenes having one or more alkyl, alkoxyl, hydroxyl or halo substituent group attached to the aromatic ring, including, e.g., alpha-methyl styrene, p-methyl styrene, vinyl toluene, vinyl xylene, trimethyl styrene, butyl styrene, chlorostyrene, dichlorostyrene, bromostyrene, p-hydroxystyrene, methoxystyrene and vinyl-substituted condensed aromatic ring structures, such as, e.g., vinyl naphthalene, vinyl anthracene, as well as mixtures of vinyl aromatic monomers.

As used in the present context the term “monoethylenically unsaturated nitrile monomer” means an acyclic compound that comprises a single nitrile group and a single site of ethylenic unsaturation per molecule and includes, e.g., acrylonitrile, methacrylonitrile, and alpha-chloro acrylonitrile.

The terminology “(meth)acrylate monomers” refers collectively to acrylate monomers and methacrylate monomers. Suitable C₁-C₁₂ alkyl (meth)acrylate monomers comprise C₁-C₁₂ alkyl acrylate monomers, e.g., ethyl acrylate, butyl acrylate, iso-pentyl acrylate, n-hexyl acrylate, 2-ethyl hexyl acrylate, and their C₁-C₁₂ alkyl methacrylate analogs such as, e.g., methyl methacrylate, ethyl methacrylate, propyl methacrylate, isopropyl methacrylate, butyl methacrylate, hexyl methacrylate, and decyl methacrylate.

In a particular embodiment the second thermoplastic resin comprises a vinyl aromatic polymer having first structural units derived from one or more vinyl aromatic monomers, for example styrene, and having second structural units derived from one or more monoethylenically unsaturated nitrile monomers, for example acrylonitrile. The second thermoplastic resin comprises in some embodiments from about 55 to about 99 wt %, and in other embodiments from about 60 to about 90 wt %, structural units derived from styrene and in some embodiments from about 1 to about 45 wt %, and in other embodiments from about 10 to about 40 wt %, structural units derived from acrylonitrile. In a particular embodiment the weight average molecular weight of a second thermoplastic resin is from about 50,000 to about 100,000 g/mol. relative to polystyrene standards.

The second thermoplastic resin may, provided that the T_{g} limitation for the resin is satisfied, optionally include structural units derived from one or more other copolymerizable monoethylenically unsaturated monomers such as, e.g., monoethylenically unsaturated carboxylic acids such as, e.g., acrylic acid, methacrylic acid, and itaconic acid; hydroxy C₁-C₁₂ alkyl (meth)acrylate monomers such as, e.g., hydroxyethyl methacrylate; C₄-C₁₂ cycloalkyl (meth)acrylate monomers such as e.g., cyclohexyl methacrylate; (meth)acrylamide monomers such as e.g., acrylamide and methacrylamide; maleimide monomers such as, e.g., N-alkyl maleimides, N-aryl maleimides; maleic anhydride; and vinyl esters such as, e.g., vinyl acetate and vinyl propionate. As used in the present context the term “C₄-C₁₂ cycloalkyl” means a cyclic alkyl substituent group having from 4 to 12 carbon atoms per group and the term “(meth)acrylamide” refers collectively to acrylamides and methacrylamides.

When present, the amount of second thermoplastic resin present in the compositions of the present invention is in one embodiment in a range of between about 0.1 wt % and about 35 wt %, in another embodiment in a range of between about 0.1 wt % and about 26 wt %, in another embodiment in a range of between about 0.5 wt % and about 22 wt %, in another embodiment in a range of between about 1 wt % and about 20 wt %, and in still another embodiment in a range of between about 10 wt % and about 18 wt %, based on the weight of the entire composition. When at least one of a second thermoplastic resin is present in the compositions of the present invention, the amount of polycarbonate present in the composition is in one embodiment in a range of between about 50 wt % and about 98 wt in another embodiment in a range of between about 60 wt % and about 95 wt %, in another embodiment in a range of between about 60 wt % and about 85 wt %, and in still another embodiment in a range of between about 65 wt % and about 84 wt %, based on the weight of the entire composition.

The flame retardant resinous compositions of the present invention may optionally comprise at least one rubber modified graft copolymer comprising a discontinuous rubber phase dispersed in a continuous rigid thermoplastic phase, wherein at least a portion of the rigid thermoplastic phase is chemically grafted to the rubber phase. Hereinafter rubber modified graft copolymer is sometimes referred to as rubber modified thermoplastic resin. In one embodiment rubber modified graft copolymers comprise those made by a bulk or, synonymously, mass, polymerization process. In another embodiment rubber modified graft copolymers comprise those made by emulsion polymerization.

Suitable rubbers for use in making the rubber phase comprise those having a glass transition temperature (T_{g}) of in one embodiment less than or equal to 25° C., in another embodiment less than or equal to 0° C., and in still another embodiment less than or equal to minus 30° C. In one embodiment the rubber comprises a polymer, often a linear polymer, having structural units derived from one or more conjugated diene monomers. Suitable conjugated diene monomers comprise, e.g., 1,3-butadiene, isoprene, 1,3-heptadiene, methyl-1,3-pentadiene, 2,3-dimethylbutadiene, 2-ethyl-1,3-pentadiene, 1,3-hexadiene, 2,4-hexadiene, dichlorobutadiene, bromobutadiene and dibromobutadiene as well as mixtures of conjugated diene monomers. In particular embodiments the conjugated diene monomer is at least one of 1,3-butadiene or isoprene.

The rubber may optionally include structural units derived from one or more copolymerizable monoethylenically unsaturated monomers selected from C₂-C₈ olefin monomers, vinyl aromatic monomers, monoethylenically unsaturated nitrile monomers, and C₁-C₁₂ alkyl (meth)acrylate monomers. As used herein, the term “C₂-C₈ olefin monomers” means a compound having from 2 to 8 carbon atoms per molecule and having a single site of ethylenic unsaturation per molecule. Suitable C₂-C₈ olefin monomers comprise, e.g., ethylene, propene, 1-butene, 1-pentene, and heptene. Suitable vinyl aromatic monomers, monoethylenically unsaturated nitrile monomers, and C₁-C₁₂ alkyl (meth)acrylate monomers comprise those set forth above in the description of the second thermoplastic resin.

In a particular embodiment the rubber is a polybutadiene homopolymer. In another embodiment the rubber is a copolymer, for example a block copolymer, comprising structural units derived from one or more conjugated diene monomers and up to 50 percent by weight (“wt %”) structural units derived from one or more monomers selected from vinyl aromatic monomers and monoethylenically unsaturated nitrile monomers, such as, for example, a styrene-butadiene copolymer, an acrylonitrile-butadiene copolymer or a styrene-butadiene-acrylonitrile copolymer. In another particular embodiment the rubber is a styrene-butadiene block copolymer that contains from about 50 to about 95 wt % structural units derived from butadiene and from about 5 to about 50 wt % structural units derived from styrene. In another particular embodiment the rubber comprises structural units derived from butyl acrylate. In another particular embodiment the rubber is an ethylene-propylene-diene modified rubber.

The elastomeric rubber phase may be made by aqueous emulsion polymerization in the presence of a free radical initiator, a polyacid surfactant and, optionally, a chain transfer agent, and coagulated to form particles of elastomeric phase material. Suitable initiators comprise conventional free radical initiators such as, e.g., an organic peroxide compound, such as e.g., benzoyl peroxide; a persulfate compound, such as, e.g., potassium persulfate; an azonitrile compound such as, e.g., 2,2′-azobis-2,3,3-trimethylbutyronitrile; or a redox initiator system, such as, e.g., a combination of cumene hydroperoxide, ferrous sulfate, tetrasodium pyrophosphate and a reducing sugar or sodium formaldehyde sulfoxylate. Suitable chain transfer agents comprise, for example, a C₉-C₁₃ alkyl mercaptan compound such as nonyl mercaptan, or t-dodecyl mercaptan.

The emulsion polymerized particles of elastomeric rubber phase material have a weight average particle size in one embodiment of about 50 to about 1000 nanometers (“nm”), in another embodiment of about 50 to about 800 nm, and in another embodiment of from 100 to 500 nm, as measured by light transmission. The size of emulsion polymerized elastomeric particles may optionally be increased by mechanical, colloidal or chemical agglomeration of the emulsion polymerized particles according to known techniques.

The rigid thermoplastic resin phase comprises one or more thermoplastic polymers and exhibits a T_{g} in one embodiment of greater than about 25° C., in another embodiment of greater than or equal to about 90° C. and in still another embodiment of greater than or equal to about 100° C. In a particular embodiment the rigid thermoplastic phase comprises one or more polymers each having structural units derived from one or more monomers selected from the group consisting of C₁-C₁₂ alkyl (meth)acrylate monomers, vinyl aromatic monomers and monoethylenically unsaturated nitrile monomers. Suitable vinyl aromatic monomers and monoethylenically unsaturated nitrile monomers and of C₁-C₁₂ alkyl (meth)acrylate monomers comprise those set forth above in the description of the rubber phase.

In a particular embodiment the rigid thermoplastic resin phase comprises a vinyl aromatic polymer having first structural units derived from one or more vinyl aromatic monomers, for example styrene, and having second structural units derived from one or more monoethylenically unsaturated nitrile monomers, for example acrylonitrile. The rigid phase comprises in some embodiments from about 55 to about 99 wt %, and in other embodiments from about 60 to about 90 wt %, structural units derived from styrene and in some embodiments from about 1 to about 45 wt %, and in other embodiments from about 10 to about 40 wt %, structural units derived from acrylonitrile.

The relative amount of rubber phase in the rubber modified graft copolymer is in one embodiment in a range between about 2 wt % and about 70 wt %, in another embodiment in a range between about 6 wt % and about 65 wt %, in another embodiment in a range between about 8 wt % and about 50 wt %, in another embodiment in a range between about 10 wt % and about 40 wt %, and in still another embodiment in a range between about 12 wt % and about 24 wt %, based on the weight of the rubber modified graft copolymer. The amount of grafting that takes place between the rigid thermoplastic phase and the rubber phase varies with the relative amount and composition of the rubber phase. In one embodiment from about 10 to about 90 wt % of the rigid thermoplastic phase is chemically grafted to the rubber phase and from about 10 to about 90 wt % of the rigid thermoplastic phase remains “free”, i.e., non-grafted. In another embodiment from about 40 to about 75 wt % of the rigid thermoplastic phase is chemically grafted to the rubber phase and from about 25 to about 60 wt % of the rigid thermoplastic phase remains free.

In various embodiments the rigid thermoplastic phase of the rubber modified thermoplastic resin may be formed: (i) solely by polymerization carried out in the presence of the rubber phase or (ii) by addition of one or more separately polymerized rigid thermoplastic polymers to a rigid thermoplastic polymer that has been polymerized in the presence of the rubber phase. In a particular embodiment one or more separately polymerized rigid thermoplastic polymers is combined with a rigid thermoplastic polymer that has been polymerized in the presence of the rubber phase in order to aid in adjusting the viscosity of the composition of the present invention into some desired range. In a particular embodiment the weight average molecular weight of the one or more separately polymerized rigid thermoplastic polymers is from about 50,000 to about 100,000 g/mol. relative to polystyrene standards.

In another particular embodiment the rubber modified thermoplastic resin comprises a rubber phase comprising a polymer having structural units derived from one or more conjugated diene monomers, and, optionally, further comprising structural units derived from one or more monomers selected from vinyl aromatic monomers and monoethylenically unsaturated nitrile monomers; and the rigid thermoplastic phase comprises a polymer having structural units derived from one or more monomers selected from vinyl aromatic monomers and monoethylenically unsaturated nitrile monomers. In still another particular embodiment the rubber phase of the rubber modified thermoplastic resin comprises a polybutadiene or poly(styrene-butadiene) rubber and the rigid phase comprises a styrene-acrylonitrile copolymer.

Each of the polymers of the rubber phase and of the rigid thermoplastic resin phase of the rubber modified thermoplastic resin may, provided that the T_{g} limitation for the respective phase is satisfied, optionally include structural units derived from one or more other copolymerizable monoethylenically unsaturated monomers such as, e.g., monoethylenically unsaturated carboxylic acids such as, e.g., acrylic acid, methacrylic acid, and itaconic acid; hydroxy C₁-C₁₂ alkyl (meth)acrylate monomers such as, e.g., hydroxyethyl methacrylate; C₄-C₁₂ cycloalkyl (meth)acrylate monomers such as e.g., cyclohexyl methacrylate; (meth)acrylamide monomers such as e.g., acrylamide and methacrylamide; maleimide monomers such as, e.g., N-alkyl maleimides, N-aryl maleimides; maleic anhydride; and vinyl esters such as, e.g., vinyl acetate and vinyl propionate. As used in the present context the term “C₄-C₁₂ cycloalkyl” means a cyclic alkyl substituent group having from 4 to 12 carbon atoms per group and the term “(meth)acrylamide” refers collectively to acrylamides and methacrylamides. The rubber phase of rubber modified thermoplastic resin has a particle size in one embodiment of from about 0.1 to about 10 micrometers (“μm”), in another embodiment of from about 0.1 to about 3.0 micrometers, and in another embodiment from about 0.2 to about 2.0 μm.

When present, the amount of rubber modified graft copolymer present in the compositions of the present invention is in one embodiment in a range of between about 0.1 wt % and about 35 wt %, in another embodiment in a range of between about 0.1 wt % and about 20 wt %, in another embodiment in a range of between about 0.2 wt % and about 16 wt %, in another embodiment in a range of between about 0.5 wt % and about 14 wt %, and in still another embodiment in a range of between about 2 wt % and about 14 wt %, based on the weight of the entire composition. When at least one rubber modified graft copolymer is present in the compositions of the present invention, the amount of polycarbonate present in the composition is in one embodiment in a range of between about 55 wt % and about 98 wt %, in another embodiment in a range of between about 60 wt % and about 95 wt %, in another embodiment in a range of between about 60 wt % and about 85 wt %, and in still another embodiment in a range of between about 65 wt % and about 84 wt %, based on the weight of the entire composition.

The compositions of the present invention encompass those comprising at least one aromatic polycarbonate resin, optionally in combination with at least one of a second thermoplastic resin which is not a polycarbonate resin, or with at least one rubber modified graft copolymer, or optionally in combination with a mixture of at least one rubber modified graft copolymer and at least one of a second thermoplastic resin which is not a polycarbonate resin. In some embodiments compositions of the present invention may comprise at least one aromatic polycarbonate resin in combination with a mixture of at least one rubber modified graft copolymer and at least one of a second thermoplastic resin which is not a polycarbonate resin, wherein the second thermoplastic resin comprises a majority of monomer structural units which are the same as those of the rigid thermoplastic phase of the rubber modified graft copolymer. When neither second thermoplastic resin which is not a polycarbonate, nor rubber modified graft copolymer is present in the compositions of the present invention, the amount of polycarbonate present in the composition is in one embodiment in a range of between about 88 wt % and about 98 wt %, and in another embodiment in a range of between about 90 wt % and about 98 wt %, based on the weight of the entire composition.

In various embodiments the flame retardant resinous compositions of the present invention comprise at least one silicone source. In one embodiment a silicone source is a copolymer comprising siloxane structural units in combination with structural units from a second, non-silicon-containing polymer. In a particular embodiment a siloxane-comprising copolymer comprises polydiorganosiloxane structural units in combination with structural units of an aromatic polycarbonate, referred to sometimes hereinafter as “PC-siloxane copolymer”. In another particular embodiment a siloxane-comprising copolymer comprises structural units of polydimethylsiloxane in combination with structural units of a bisphenol A polycarbonate. In some embodiments the siloxane-comprising copolymer is derived from a polydimethylsiloxane terminated with at least one hydroxyaryl group, said polydimethylsiloxane being polymerized into a bisphenol A-comprising polycarbonate. The PC-siloxane copolymers comprise block copolymers containing in one embodiment between about 0.5 wt % and about 80 wt % polydiorganosiloxane, in another embodiment between about 1 wt % and about 60 wt % polydiorganosiloxane, in another embodiment between about 2 wt % and about 50 wt % polydiorganosiloxane, and in still another embodiment between about 3 wt % and about 40 wt % polydiorganosiloxane. The PC-siloxane block copolymers comprise an average block length in one embodiment of about 2 to about 100 diorganosiloxane structural units, in another embodiment of about 2 to about 60 diorganosiloxane structural units, and in still another embodiment of about 2 to about 50 diorganosiloxane structural units. PC-siloxane copolymers and methods to make them are known in the art and are disclosed in such patents as U.S. Pat. Nos. 5,530,083; 5,616,674; and 6,072,011.

In another embodiment a suitable silicone source is a poly(diorganosiloxane). Poly(diorganosiloxane)s usually comprise a main chain of alternating silicon atoms and oxygen atoms, substituted with various organic groups at the silicon atom. In various embodiments poly(diorganosiloxane)s have the structure shown in formula (V):

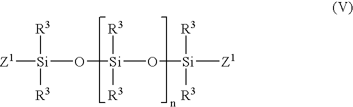

wherein each R³ independently represents C₁₋₁₅ alkyl, C₂₋₁₀ alkenyl, C₅ 12 cycloalkyl, or aryl, which groups may be halogenated, particularly fluorinated; Z¹ represents R³ or OH; and wherein “n” is such that the compound has a nominal weight average molecular weight of from about 500 to about 1,500,000 grams/mole. In one embodiment the poly(diorganosiloxane) comprises dimethylsiloxane structural units. In a particular embodiment the poly(diorganosiloxane) comprises poly(dimethylsiloxane). In some embodiments suitable poly(dimethylsiloxanes) have a viscosity in a range of between about 5 cSt (centiStokes) and about 1000 cSt. In another particular embodiment the poly(diorganosiloxane) comprises dimethylsiloxane structural units in combination with diphenylsiloxane or methylphenylsiloxane structural units.

In another particular embodiment a suitable silicone source is a hydroxy-terminated poly(diorganosiloxane), wherein said hydroxy group is directly bonded to silicon as in formula (V) wherein Z¹ is OH. In some embodiments a hydroxy-terminated poly(diorganosiloxane) is a hydroxy-terminated poly(dimethylsiloxane). Suitable hydroxy-terminated poly(diorganosiloxanes) have a viscosity in one embodiment in a range of between about 5 cSt and about 115,000 cSt; in another embodiment in a range of between about 5 cSt and about 50,000 cSt; in another embodiment in a range of between about 10 cSt and about 25,000 cSt; in another embodiment in a range of between about 20 cSt and about 10,000 cSt; in another embodiment in a range of between about 25 cSt and about 5,000 cSt; in another embodiment in a range of between about 25 cSt and about 3,000 cSt; in another embodiment in a range of between about 25 cSt and about 2,000 cSt; and in still another embodiment in a range of between about 25 cSt and about 1,000 cSt.

It is also within the scope of the invention to employ polysiloxanes represented by the formulae (VI), (VII), and (VI):

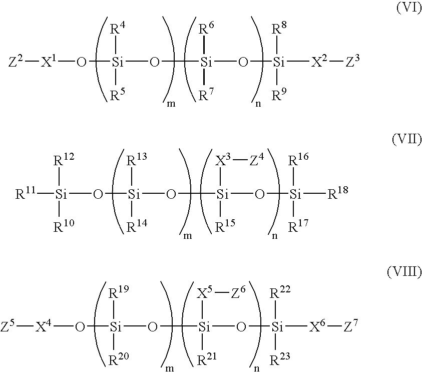

wherein “m”+“n” in each formula has a value of about 5 to about 2,000, and the twenty moieties R⁴-R²³, each independently of each other, represent a hydrogen atom or one of the following groups having 1 to 12 carbon atoms: alkyl, alkoxy, alkenyl, aryl, aralkyl, alkylaryl, which groups may be halogenated; wherein X¹, X², X³, X⁴, X⁵, and X⁶, each independently of each other, represent one of the following groups: alkylene, cycloalkylene, arylene, aralkylene, alkylarylene; wherein Z², Z³, Z⁴, Z⁵, Z⁶, and Z⁷ each independently represent one of the following groups:

(a) —NR²⁴R²⁵ and (—NH—(CH₂)ₖ—NR²⁴R²⁵) in which R²⁴ and R²⁵, each independently of each other, represent a hydrogen atom or an alkyl group having 1-12 carbon atoms, “k” has a value from 1-10;

(b) an aliphatic or cycloaliphatic epoxide;

(c) a carboxylic acid or anhydride group;

in which, however, the functionalized poly(diorganosiloxane) compound may not comprise simultaneously an amine group and an epoxide group, or not simultaneously an amine group and a carboxylic acid group, or not simultaneously an epoxide group and a carboxylic acid or anhydride group.

In another particular embodiment suitable silicone sources are represented by the formula (IX)

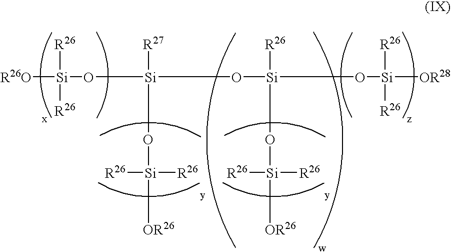

wherein each R²⁶ is independently a C₁₋₅ alkyl group and R²⁷ is a C₁₋₅ alkyl group or a primary or secondary amino group such as a N-(2-aminoalkyl)-3-aminoalkyl group. In particular embodiments R²⁶ is a methyl group. In various embodiments R²⁷ is a methyl group or a N-(2-aminoethyl)-3-aminopropyl group. In various embodiments R²⁸ is hydrogen or a C₁₋₅ alkyl group. In particular embodiments R²⁸ is a methyl group. The parameter “w” has a value of 0 or 1, and “x” and “y” are each independently an integer from 1 to about 50, and “z” is an integer from 0 to about 7. It is noted herein that any combination of compounds represented by formula (IX) may be employed.

In another particular embodiment suitable silicone sources are represented by the formula (X)

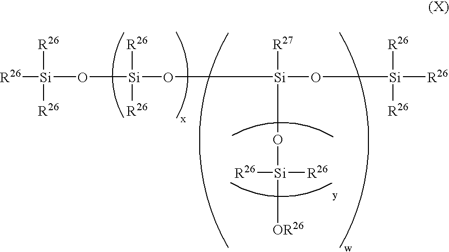

wherein each R²⁶ is independently a C₁₋₅ alkyl group and R²⁷ is a C₁₋₅ alkyl group or a primary or secondary amino group such as a N-(2-aminoalkyl)-3-aminoalkyl group. In particular embodiments R²⁶ is a methyl group. In various embodiments R²⁷ is a N-(2-aminoethyl)-3-aminopropyl group. The parameter “w” has a value of 1 to about 18, and “x” and “y” are each independently an integer from 1 to about 50. It is noted herein that any combination of compounds represented by formula (X) may be employed.

In other embodiments the silicone source may comprise at least one low molecular weight non-polymeric molecule comprising at least one silicon atom, at least one aromatic moiety, and at least one hydroxy group. Low molecular weight in the present context means in one embodiment a molecular weight below about 500, in another embodiment a molecular weight below about 400, and in still another embodiment a molecular weight below about 300. Aromatic moieties may be unsubstituted or substituted, for example with alkyl or halogen groups. In some embodiments aromatic moieties are unsubstituted phenyl groups. Hydroxy groups may be bonded directly to silicon or to an alkyl group bonded to silicon. In various embodiments said low molecular weight molecules comprising at least one silicon atom are phenyl silanols such as diphenylsilanediol. In some embodiments mixtures of at least one of said low molecular weight molecule with at least one other silicone source are employed. In particular embodiments mixtures of diphenylsilanediol with at least one other silicone source, such as PC-siloxane copolymer, are employed.

A silicone source is present in the compositions of the present invention in an amount in one embodiment in a range of between about 0.1 wt % and about 10 wt %, in another embodiment in a range of between about 0.2 wt % and about 6 wt %, in another embodiment in a range of between about 0.2 wt % and about 5 wt %, and in still another embodiment in a range of between about 0.4 wt % and about 3 wt %, based on the weight of the entire composition. When the silicone source is present in the compositions as a copolymer comprising siloxane structural units in combination with structural units from a second, non-silicone polymer, then the amount of silicone source is calculated based on the wt % of siloxane structural units in the copolymer.

In various embodiments the flame retardant resinous compositions of the present invention comprise at least one boron source. Suitable boron sources comprise boron compounds such as boric acid, boron oxide (B₂O₃), boron phosphate, and the like. A boron source is present in the compositions of the present invention in an amount in one embodiment in a range of between about 0.1 wt % and about 10 wt in another embodiment in a range of between about 0.2 wt % and about 6 wt %, in another embodiment in a range of between about 0.2 wt % and about 5 wt %, and in still another embodiment in a range of between about 0.2 wt % and about 2 wt %, based on the weight of the entire composition. In some embodiments compositions comprising amounts of boron source less than 0.1 wt % result in difficulty in processing the composition.

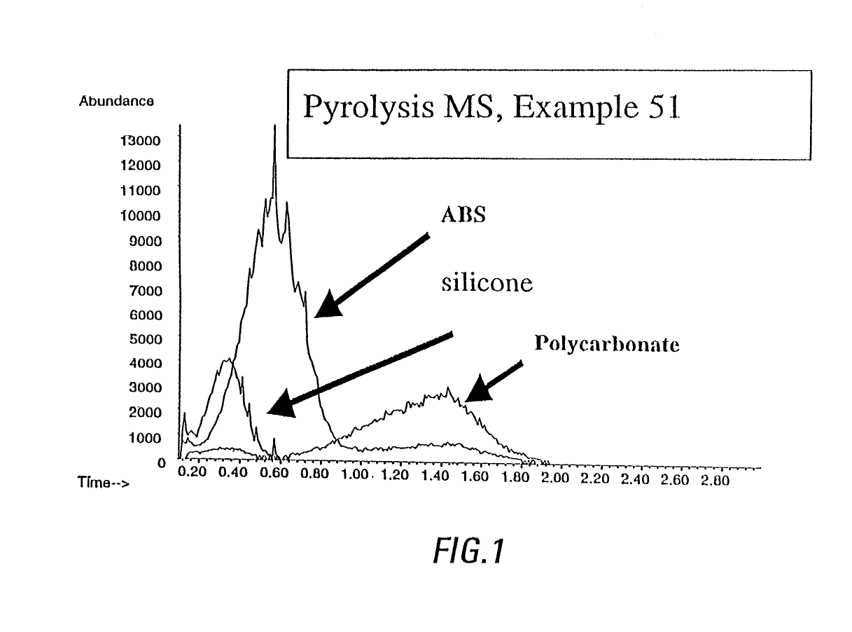

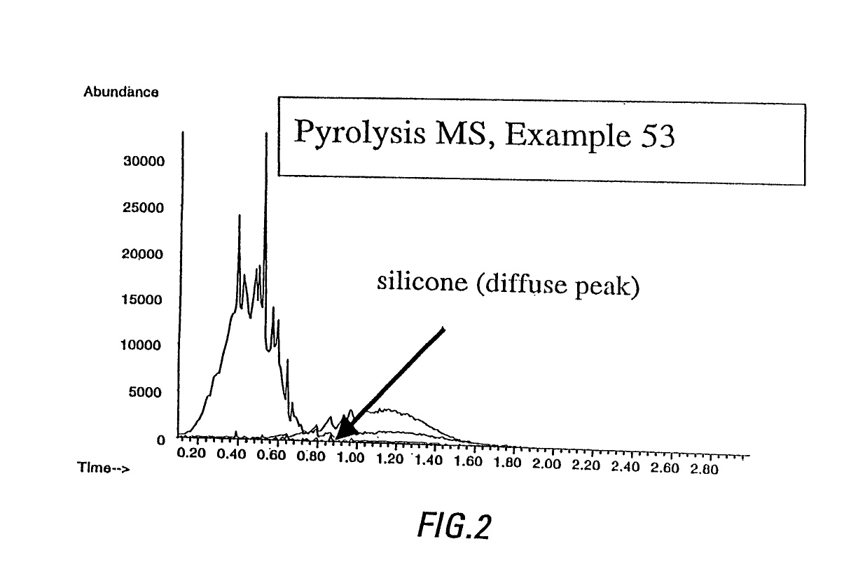

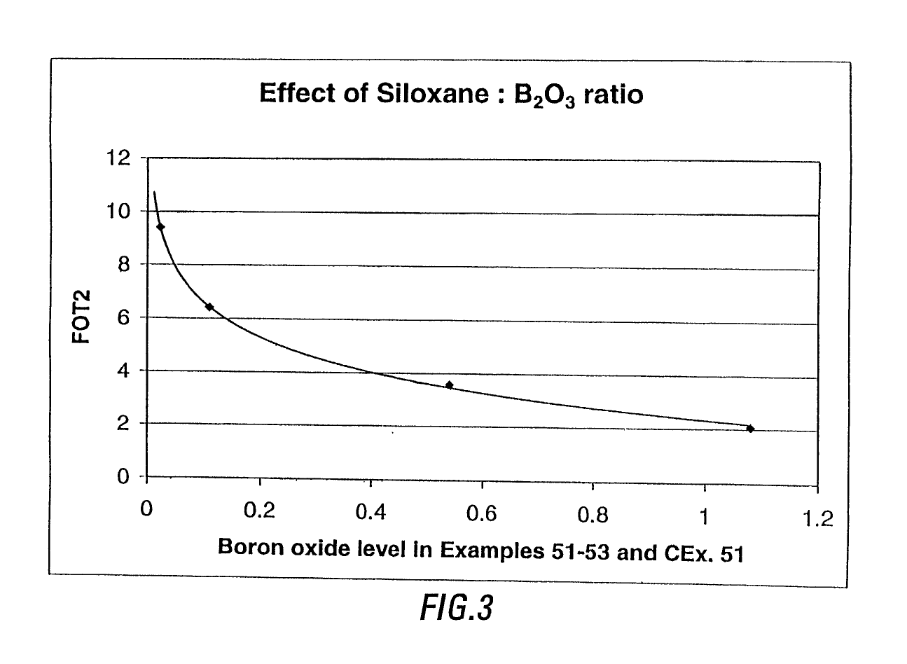

The present inventors have unexpectedly discovered that the presence of both a siloxane source and a boron source in the compositions of the present invention results in a synergistic effect on flame retardancy. Although the present invention is not dependent upon theory of operation, it is believed that at least one possible mechanism for the efficacy of silicone species for promoting flame retardancy in thermoplastic resin compositions is the decomposition of silicone species to volatile species (such as cyclic siloxanes) which have a lower heat of combustion than volatile fuel components derived from thermoplastic resin during burning. Therefore, in one of its embodiments the present invention includes compositions which comprise at least one silicone source and at least one silicone decomposition agent or catalyst. In another of its embodiments the present invention includes compositions which comprise at least one silicone source and at least one boron source which is a silicone decomposition agent or catalyst. FIG. 1 shows pyrolysis mass spectroscopic data for the processed composition of Example 51 which comprises 2.66 wt % siloxane and 1.08 wt % boron source. FIG. 2 shows pyrolysis mass spectroscopic data for the processed composition of Example 53 which comprises 2.66 wt % siloxane and 0.11 wt % boron source. Comparison of the data in FIG. 1 with the data shown in FIG. 2 shows that the composition comprising 10 times as much boron source (FIG. 1) exhibits earlier decomposition of siloxane than the composition comprising less boron source (FIG. 2). The composition of FIG. 1 comprising 10 times as much boron source also showed decreased FOT compared to the composition of FIG. 2 comprising less boron source. FIG. 3 shows a graph of second flame out time (FOT2) versus the boron oxide level in the processed compositions of Examples 51-53 and CEx. 51. These latter examples comprise increasing levels of boron oxide at constant siloxane level. It can be seen from the data in FIG. 3 that at constant siloxane level FOT2 decreases with increasing boron oxide level.

In various embodiments the flame retardant resinous compositions of the present invention optionally comprise a fluoropolymer in an amount that is effective to provide anti-drip properties to the resin composition. The amount of fluoropolymer present in the compositions is in one embodiment in a range of between about 0.01 wt % and about 2 wt %, and in another embodiment in a range of between about 0.1 wt % and about 1 wt %, based on the weight of the entire composition. Suitable fluoropolymers and methods for making such fluoropolymers are known, see, e.g., U.S. Pat. Nos. 3,671,487 and 3,723,373. Suitable fluoropolymers include homopolymers and copolymers that comprise structural units derived from one or more fluorinated alpha-olefin monomers. The term “fluorinated alpha-olefin monomer” means an alpha-olefin monomer that includes at least one fluorine atom substituent. Suitable fluorinated alpha-olefin monomers include, e.g., fluoroethylenes such as, e.g., CF₂═CF₂, CHF═CF₂, CH₂═CF₂, CH₂═CHF, CClF═CF₂, CCl₂═CF₂, CClF═CClF, CHF═CCl₂, CH₂═CClF, and CCl₂═CClF and fluoropropylenes such as, e.g., CF₃CF═CF₂, CF₃CH═CHF, CF₃CH═CF₂, CF₃CH═CH₂, CF₃CF═CHF, CHF₂CH═CHF and CF₃CF═CH₂. In a particular embodiment the fluorinated alpha-olefin monomer is one or more of tetrafluoroethylene (CF₂═CF₂), chlorotrifluoroethylene (CClF═CF₂), vinylidene fluoride (CH₂═CF₂) and hexafluoropropylene (CF₂═CFCF₃). In various embodiments suitable fluorinated alpha-olefin homopolymers include e.g., poly(tetrafluoroethylene) and poly(hexafluoroethylene).

In other embodiments suitable fluorinated alpha-olefin copolymers include copolymers comprising structural units derived from two or more fluorinated alpha-olefin copolymers such as, e.g., poly(tetrafluoroethylene-hexafluoroethylene), and copolymers comprising structural units derived from one or more fluorinated monomers and one or more non-fluorinated monoethylenically unsaturated monomers that are copolymerizable with the fluorinated monomers such as, e.g., poly(tetrafluoroethylene-ethylene-propylene) copolymers. Suitable non-fluorinated monoethylenically unsaturated monomers include e.g., alpha-olefin monomers such as, e.g., ethylene, propylene, butene, acrylate monomers such as e.g., methyl methacrylate, butyl acrylate, vinyl ethers, such as, e.g., cyclohexyl vinyl ether, ethyl vinyl ether, n-butyl vinyl ether, vinyl esters such as, e.g., vinyl acetate, vinyl versatate. In a particular embodiment the fluoropolymer particles range in size from about 50 nm to about 500 nm as measured by electron microscopy. In a particular embodiment the fluoropolymer is a poly(tetrafluoroethylene) homopolymer (“PTFE”).

Since direct incorporation of a fluoropolymer into a thermoplastic resin composition tends to be difficult, the fluoropolymer may in one embodiment be preblended in some manner with a second polymer to form a concentrate. In one embodiment the second polymer is at least one other resinous component of the composition. In a particular embodiment the second polymer is a thermoplastic resin, such as for example an aromatic polycarbonate resin or a styrene-acrylonitrile resin. For example, an aqueous dispersion of fluoropolymer and a polycarbonate resin may be steam precipitated to form a fluoropolymer concentrate for use as a drip inhibitor additive in thermoplastic resin compositions, as disclosed in, for example, U.S. Pat. No. 5,521,230, or, alternatively, an aqueous styrene-acrylonitrile resin emulsion, or an aqueous acrylonitrile-butadiene-styrene resin emulsion may be used, wherein following precipitation a co-coagulated fluoropolymer-thermoplastic resin composition is dried to provide a PTFE-thermoplastic resin powder as disclosed in, for example, U.S. Pat. No. 4,579,906.

The fluoropolymer additive in the form of fluoropolymer-thermoplastic resin powder comprises in one embodiment from about 10 to about 90 wt %, in another embodiment from about 30 to about 70 wt %, and in still another embodiment from about 40 to about 60 wt % fluoropolymer, and in one embodiment from about 30 to about 70 wt %, and in another embodiment from about 40 to about 60 wt % of the second polymer.

In another embodiment a fluoropolymer additive may be made by emulsion polymerization of one or more monoethylenically unsaturated monomers in the presence of aqueous fluoropolymer dispersion to form a second polymer in the presence of the fluoropolymer. Suitable monoethylenically unsaturated monomers are disclosed above. The emulsion is then precipitated, e.g., by addition of sulfuric acid. The precipitate is dewatered, e.g., by centrifugation, and then dried to form a fluoropolymer additive that comprises fluoropolymer and an associated second polymer. The dry emulsion polymerized fluoropolymer additive is in the form of a free-flowing powder. In another embodiment the monoethylenically unsaturated monomers that are emulsion polymerized to form the second polymer comprise one or more monomers selected from vinyl aromatic monomers, monoethylenically unsaturated nitrile monomers and C₁-C₁₂ alkyl (meth)acrylate monomers. Suitable vinyl aromatic monomers, monoethylenically unsaturated nitrile monomers and C₁-C₁₂ alkyl (meth)acrylate monomers are disclosed above. In a particular embodiment the second polymer comprises structural units derived from styrene and acrylonitrile. In another particular embodiment the second polymer comprises from about 60 to about 90 wt % structural units derived from styrene and from about 10 to about 40 wt % structural units derived from acrylonitrile. The emulsion polymerization reaction mixture may optionally include emulsified or dispersed particles of a third polymer, such as, e.g., an emulsified butadiene rubber latex. The emulsion polymerization reaction may be initiated using a conventional free radical initiator, as disclosed above with respect to the rubber modified graft copolymer. A chain transfer agent such as, e.g., a C₉-C₁₃ alkyl mercaptan compound such as nonyl mercaptan, t-dodecyl mercaptan, may, optionally, be added to the reaction vessel during the polymerization reaction to reduce the molecular weight of the second polymer. In a particular embodiment, no chain transfer agent is used. In another embodiment, the stabilized fluoropolymer dispersion is charged to a reaction vessel and heated with stirring. The initiator system and the one or more monoethylenically unsaturated monomers are then charged to the reaction vessel and heated to polymerize the monomers in the presence of the fluoropolymer particles of the dispersion to thereby form the second polymer. Suitable fluoropolymer additives and emulsion polymerization methods are disclosed, for example, in U.S. Pat. No. 5,804,654. In a particular embodiment, the second polymer exhibits a weight average molecular weight of from about 10,000 to about 200,000 g/mol. relative to polystyrene standards.

The flame retardant resinous compositions of the present invention may optionally comprise at least one polymeric or non-polymeric organic phosphorus species selected from the group consisting of phosphate esters, thiophosphate esters, phosphonate esters, thiophosphonate esters, phosphinate esters, thiophosphinate esters, phosphines, including triphenylphosphine, phosphine oxides, including triphenylphosphine oxide and tris(2-cyanoethyl)phosphine oxide, thiophosphine oxides, and phosphonium salts. In some embodiments organic phosphorus species are non-polymeric phosphate esters including, for example, alkyl phosphate esters, aryl phosphate esters, resorcinol-based phosphate esters, and bisphenol-based phosphate esters. In other embodiments organic phosphorus species are aromatic phosphates. Illustrative, non-limiting examples of such phosphorus species include triphenylphosphate, tricresylphosphate, resorcinol bis(diphenylphosphate), bisphenol A bis(diphenylphosphate), and other aromatic phosphate esters known in the art.

When present, the organic phosphorus species is present in the compositions of the invention in an amount in one embodiment in a range of between about 0.5 wt % and about 15 wt %, in another embodiment in a range of between about 1 wt % and about 8 wt %, and in still another embodiment in a range of between about 2 wt % and about 6 wt %, based on the weight of the entire composition.

The term “alkyl” as used in the various embodiments of the present invention is intended to designate both normal alkyl, branched alkyl, aralkyl, and cycloalkyl radicals. In various embodiments normal and branched alkyl radicals are those containing from 1 to about 12 carbon atoms, and include as illustrative non-limiting examples methyl, ethyl, n-propyl, isopropyl, n-butyl, sec-butyl, tertiary-butyl, pentyl, neopentyl, hexyl, heptyl, octyl, nonyl, decyl, undecyl and dodecyl. In various embodiments cycloalkyl radicals represented are those containing from 3 to about 12 ring carbon atoms. Some illustrative non-limiting examples of these cycloalkyl radicals include cyclobutyl, cyclopentyl, cyclohexyl, methylcyclohexyl, and cycloheptyl. In various embodiments aralkyl radicals are those containing from 7 to about 14 carbon atoms; these include, but are not limited to, benzyl, phenylbutyl, phenylpropyl, and phenylethyl. In various embodiments aryl radicals used in the various embodiments of the present invention are those containing from 6 to 12 ring carbon atoms. Some illustrative non-limiting examples of these aryl radicals include phenyl, biphenyl, and naphthyl. Halogen radicals used in some embodiments of the present invention are chlorine and bromine.

The flame retardant resinous compositions of the present invention may optionally comprise at least one stabilizer which is a polyfunctional alcohol. Suitable polyfunctional alcohols comprise those with at least two hydroxy groups. Examples of polyfunctional alcohols comprise mannitol, sorbitol, fructose, glucose, pentaerythritol, cyclodextrin, sucrose, galactose, maltose, ribose, and xylitol. In particular embodiments polyfunctional alcohols comprise mannitol, sorbitol, pentaerythritol, and fructose. Although the invention is not dependent upon any theory of operation, it is possible that under certain processing conditions polyfunctional alcohol stabilizers may form a complex with a boron source such as boric acid or boron oxide. Therefore, in one embodiment the present invention includes compositions which comprise at least one boron source and at least one stabilizer for the boron source. In another embodiment the present invention includes compositions which comprise at least one boron source and at least one polyfunctional alcohol which is capable of forming a complex with a boron source. In various embodiments the presence of at least one polyfunctional alcohol stabilizer in compositions of the invention results in improved resistance to degradation of polycarbonate molecular weight in compositions of the present invention. Polycarbonate molecular weight degradation may be measured by methods known in the art, such as by gel permeation chromatography, melt viscosity, or melt flow. In compositions where significant polycarbonate molecular weight degradation has occurred, there may be undesirable surface appearance in molded parts. Compositions which comprise at least one polyfunctional alcohol stabilizer often show improved appearance of molded part surfaces and other beneficial properties. A polyfunctional alcohol stabilizer may optionally be present in the compositions of the present invention in an amount in one embodiment in a range of between about 0.1 wt % and about 10 wt %, in another embodiment in a range of between about 0.2 wt % and about 6 wt %, in another embodiment in a range of between about 0.3 wt % and about 4 wt %, and in still another embodiment in a range of between about 0.5 wt % and about 3.5 wt %, based on the weight of the entire composition.

The flame retardant resinous compositions of the invention may also contain other conventional additives including antistatic agents, stabilizers such as heat stabilizers and light stabilizers, pigments, dyes, UV screeners, inhibitors, plasticizers, flow promoters, auxiliary flame retardants, mold release agents, impact modifiers, ester interchange inhibitors, other anti-drip agents, and fillers. In some embodiments compositions of the invention comprise either at least one extending filler, or at least one reinforcing filler, or both of at least one extending filler and at least one reinforcing filler. Representative examples of extending fillers comprise carbon black, silica, alumina, magnesia, talc, nica, glass beads, hollow glass beads, and the like. Representative examples of reinforcing fillers comprise carbon fibers, glass fibers, quartz, and the like. Representative examples of mold release agents include pentaerythritol tetrastearate, octyl behenate, and polyethylene.

Although the invention is not dependent upon any theory of operation, it is possible that under certain processing conditions additives or polymeric resins or both may at least partially react through processes well known in the art, for example complexation, transesterification or dehydration. In one embodiment it is possible that a boric acid additive in compositions of the invention may at least partially convert to boron oxide. The various embodiments of the invention are inclusive of compositions in which one or more of components has undergone chemical reaction, either by itself or in combination with at least one other blend component. That is, the invention includes both compositions comprising said components as initially present and compositions comprising any reaction products thereof. When proportions are specified in the compositions, they apply to the originally incorporated materials rather than those remaining after any such reaction.

In another embodiment the present invention comprises methods for making the compositions disclosed herein. The flame retardant resinous compositions of the present invention may be made by combining and mixing the components of the composition under conditions suitable for the formation of a blend of the components, such as for example, by melt mixing using, for example, a two-roll mill, a Banbury mixer or a single screw or twin-screw extruder, and, optionally, then reducing the composition so formed to particulate form, e.g., by pelletizing or grinding the composition. In some embodiments one or more components can be added to the composition as an aqueous mixture or solution followed by devolatilization in appropriate processing equipment such as in an extruder. In another embodiment boron source and stabilizer may be mixed in aqueous solution and then evaporated to form a material which can be added to compositions of the invention. The thermoplastic resin compositions of the present invention can be molded into useful shaped articles by a variety of means such as injection molding, extrusion, rotational molding, blow molding and thermoforming to form articles such as, for example, computer and business machine housings, home appliances.

The compositions of the present invention comprising at least one polycarbonate, at least one silicone source, at least one boron source, at least one antidrip agent, and optionally at least one of a second thermoplastic resin which is not a polycarbonate or at least one rubber modified graft copolymer, or optionally a mixture of at least one rubber modified graft copolymer and at least one of a second thermoplastic resin which is not a polycarbonate resin show improved flame resistance as tested by the UL94 testing protocol. Compositions comprising silicone source or boron source also often show improved resistance to drip during the flame test. The invention allows for elimination of halogen-based flame retardants, and a reduction or elimination of phosphorus-based flame retardants which can negatively affect physical properties such as polycarbonate glass transition temperature and concomitant heat deflection temperature of composition molded parts.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

In the following examples the components were bisphenol A polycarbonate with a weight average molecular weight (relative to polystyrene standards) in a range of between about 40,000 and about 50,000; ABS comprising about a 75:25 weight ratio of styrene to acrylonitrile and about 8-25% grafted polybutadiene with overall weight average molecular weight of the styrene/acrylonitrile portion in a range of between about 50,000 and about 100,000 relative to polystyrene standards; SAN comprising about a 75:25 weight ratio of styrene to acrylonitrile with overall weight average molecular weight in a range of between about 50,000 and about 100,000 relative to polystyrene standards; and, unless noted, polytetrafluoroethylene added as a 50 wt % concentrate in SAN to provide 0.25 wt % polytetrafluoroethylene based on the total weight of the composition. Unless noted, all of the compositions in the examples also contained 0.66 wt % of mold release agents and thermal stabilizers which are not believed to affect the flame resistance properties. Certain examples contained PC-siloxane copolymer as silicone source. Unless noted, PC-siloxane copolymer was about 20 wt % polydimethylsiloxane-containing copolymer with bisphenol A polycarbonate, wherein the initial silicone starting material has a degree of polymerization of about 50 (D50). In certain examples an organic phosphate was added to a composition as noted. Compositions in the examples were prepared by dry blending in a Henschel mixer following by extrusion and molding. Flame resistance of molded compositions was measured by the UL94 protocol using one-sixteenth inch thick test bars which had been conditioned for 48 hours at room temperature and 50% relative humidity. Char yields were measured by thermogravimetric analysis (TGA) under nitrogen at a heating rate of 100° K per minute, attaining a maximum temperature of 800° K, followed by holding at 800° K for 5 minutes under nitrogen, then holding at 800° K for 5 minutes under air. The char yield data are reported in the following tables both after 5 minutes holding at 800° K under nitrogen and after 5 minutes holding at 800° K under air. Glass transition temperatures (Tg) for the polycarbonate phase in the compositions was determined by differential scanning calorimetry (DSC) under nitrogen at a heating rate of 20° C. per minute. The abbreviation “CEx.” means comparative example.

### EXAMPLES 1-6 AND COMPARATIVE EXAMPLE 1

A control composition (CEx. 1) was prepared comprising 67.96 wt % polycarbonate, 12.5 wt % ABS, 12.5 wt % SAN, and 5.88 wt % resorcinol diphosphate (RDP), wherein all wt % values are based on the weight of the entire composition. Compositions of the invention were prepared by replacing a portion of the polycarbonate in the control composition with either PC-siloxane copolymer or boric acid, or both PC-siloxane copolymer and boric acid as noted in the Table. The results for flame resistance tests are shown in Table 1 compared to the control composition without PC-siloxane copolymer or boric acid.

TABLE 1

| | | No. of Drips | | | Char | |
|---|---|---|---|---|---|---|
| | | per total | FOT1 | FOT2 | Yield | |
| | Additive | number of | (avg. | (avg. | (wt %; | Tg |
| Ex. | (wt %) | test parts | seconds) | seconds) | N₂/air) | (° C.) |
| CEx.1 | — | 10/10 | 0.9 | — | 15.1/0 | 118.5 |
| 1 | PC-siloxane (0.5) | 3/10 | 44.2 | — | — | — |
| 2 | boric acid (0.38) | 2/10 | 2.4 | 24.7 | — | — |
| 3 | PC-siloxane (0.5) | 0/5 | 2.0 | >60 | — | — |
| | boric acid (0.38) | | | | | |
| 4 | PC-siloxane (2.5) | 0/10 | 9.9 | 50 | 15.5/0.9 | 118.8 |
| 5 | boric acid (1.92) | 8/9 | 4.6 | 63.8 | 16.3/4 | — |
| 6 | PC-siloxane (2.5) | 0/10 | 2.5 | 28.8 | 18.9/3.3 | 120.9 |
| | boric acid (1.92) | | | | | |

The compositions comprising a mixture of both PC-siloxane copolymer and boric acid show improved flame resistance and improved char yield with no decrease in Tg for the polycarbonate phase compared to the control composition and the compositions with either PC-siloxane copolymer alone or boric acid alone. Compositions comprising PC-siloxane copolymer or boric acid also showed improved resistance to drip during the flame test.

### EXAMPLES 7-12 AND COMPARATIVE EXAMPLE 7

A control composition (CEx. 7) was prepared comprising 83.84 wt % polycarbonate and 15 wt % SAN, wherein all wt % values are based on the weight of the entire composition. Compositions of the invention were prepared by replacing a portion of the polycarbonate in the control composition with either PC-siloxane copolymer or boric acid, or both PC-siloxane copolymer and boric acid as noted in the Table. The results for flame resistance tests are shown in Table 2 compared to the control composition without PC-siloxane copolymer or boric acid.

TABLE 2

| | | No. of Drips | | | Char | |
|---|---|---|---|---|---|---|
| | | per total | FOT1 | FOT2 | Yield | |
| | Additive | number of | (avg. | (avg. | (wt %; | Tg |
| Ex. | (wt %) | test parts | seconds) | seconds) | N₂/air) | (° C.) |
| CEx.7 | — | 7/8 | 63 | — | 18.7/0 | 143.8 |
| 7 | PC-siloxane (0.5) | 5/5 | — | — | — | — |
| 8 | boric acid (0.38) | 3/5 | 39.8 | — | — | — |
| 9 | PC-siloxane (0.5) | 0/5 | 8.6 | >60 | — | — |
| | boric acid (0.38) | | | | | |
| 10 | PC-siloxane (2.5) | 2/5 | 60 | — | 18.3/0.4 | 143.7 |
| 11 | boric acid (1.92) | 8/10 | 82 | — | 19.9/2.4 | — |
| 12 | PC-siloxane (2.5) | 0/10 | 4.4 | 33.1 | 20.7/0.8 | 141.2 |
| | boric acid (1.92) | | | | | |

The compositions comprising a mixture of both PC-siloxane copolymer and boric acid show improved flame resistance and improved char yield with no significant decrease in Tg for the polycarbonate phase compared to the control composition and the compositions with either PC-siloxane copolymer alone or boric acid alone.

### EXAMPLES 13-18 AND COMPARATIVE EXAMPLE 13

A control composition (CEx. 13) was prepared comprising 92.4 wt % polycarbonate; 4 wt % ABS; 2 wt % bisphenol A diphosphate (BPADP); 1% of a 50% concentrate of polytetrafluoroethylene in SAN; and 0.6 wt % mold release agents and thermal stabilizers, wherein all wt % values are based on the weight of the entire composition. Compositions of the invention were prepared by replacing a portion of the polycarbonate in the control composition with either PC-siloxane copolymer or boric acid, or both PC-siloxane copolymer and boric acid as noted in the Table. The results for flame resistance tests are shown in Table 3 compared to the control composition without PC-siloxane copolymer or boric acid.

TABLE 3

| | | No. of Drips | | | Char | |
|---|---|---|---|---|---|---|
| | | per total | FOT1 | FOT2 | Yield | |
| | Additive | number of | (avg. | (avg. | (wt %; | Tg |
| Ex. | (wt %) | test parts | seconds) | seconds) | N₂/air) | (° C.) |
| CEx.13 | — | 3/10 | 1.6 | 9.2 | 19.2/0 | 137.3 |
| 13 | PC-siloxane (0.5) | 0/5 | 43.8 | 28.4 | — | — |
| 14 | boric acid (0.38) | 1/10 | 1.1 | 9.3 | — | — |
| 15 | PC-siloxane (0.5) | 0/10 | 4.1 | 15.1 | — | — |
| | boric acid (0.38) | | | | | |
| 16 | PC-siloxane (2.5) | 0/10 | 3.7 | 8.7 | 21.0/0.6 | 132.8 |
| 17 | boric acid (1.92) | 0/10 | 1.1 | 8.0 | 23.4/3.2 | — |
| 18 | PC-siloxane (2.5) | 0/10 | 2.0 | 3.9 | 24.8/1.8 | 133.2 |
| | boric acid (1.92) | | | | | |

The compositions comprising a mixture of both PC-siloxane copolymer and boric acid show improved flame resistance and improved char yield with no significant decrease in Tg for the polycarbonate phase compared to the control composition and the compositions with either PC-siloxane copolymer alone or boric acid alone.

The processed compositions of Examples 16 and 18 were subjected to pyrolysis mass spectroscopy using the following method. Approximately 1 milligram of the composition was placed in the crucible of a thermogravimetric analyzer, and the crucible was placed in a furnace already heated to 700° C. Helium gas was passed continuously through the furnace, passing ultimately to a Hewlett-Packard model 5973 mass selective detector. The helium gas flow was split twice before reaching the detector to provide a sample of appropriate size for analysis. Mass spectra were recorded at a rate of approximately one per second over a mass range of 10-800 as the sample heated up. Data were collected over a 3 minute period. Full mass spectra were acquired. Extracted ion chromatograms were produced for m/z 94, 104, and 281 to monitor polycarbonate, ABS, and silicone decomposition kinetics.

### EXAMPLES 19-24 AND COMPARATIVE EXAMPLE 19

A control composition (CEx. 19) was prepared comprising 94.4 wt % polycarbonate; 4 wt % ABS; 1% of a 50% concentrate of polytetrafluoroethylene in SAN; and 0.6 wt % mold release agents and thermal stabilizers, wherein all wt % values are based on the weight of the entire composition. Compositions of the invention were prepared by replacing a portion of the polycarbonate in the control composition with either PC-siloxane copolymer or boric acid, or both PC-siloxane copolymer and boric acid as noted in the Table. The results for flame resistance tests are shown in Table 4 compared to the control composition without PC-siloxane copolymer or boric acid.

TABLE 4

| | | No. of Drips | | | Char | |
|---|---|---|---|---|---|---|
| | | per total | FOT1 | FOT2 | Yield | |
| | Additive | number of | (avg. | (avg. | (wt %; | Tg |
| Ex. | (wt %) | test parts | seconds) | seconds) | N₂/air) | (° C.) |
| CEx.19 | — | 7/9 | 7.5 | — | 21.2/0 | 145.7 |
| 19 | PC-siloxane (0.5) | 1/5 | >60 | — | — | — |
| 20 | boric acid (0.38) | 2/10 | 1.7 | 32.5 | — | — |
| 21 | PC-siloxane (0.5) | 0/10 | 10.7 | 29.8 | — | — |
| | boric acid (0.38) | | | | | |
| 22 | PC-siloxane (2.5) | 0/10 | 17 | 29.9 | 21.0/0.7 | 145.2 |
| 23 | boric acid (1.92) | 0/10 | 1.6 | 11.9 | 23.9/2.1 | — |
| 24 | PC-siloxane (2.5) | 0/10 | 2.9 | 4.6 | 21.8/1.9 | 142.4 |
| | boric acid (1.92) | | | | | |

The compositions comprising a mixture of both PC-siloxane copolymer and boric acid show improved flame resistance with no significant decrease in Tg for the polycarbonate phase compared to the control composition, and the compositions with either PC-siloxane copolymer alone or boric acid alone.

### EXAMPLES 25-30 and COMPARATIVE EXAMPLE 25

A control composition (CEx. 25) was prepared comprising 98.4 wt % polycarbonate; 1% of a 50% concentrate of polytetrafluoroethylene in SAN; and 0.6 wt % mold release agents and thermal stabilizers, wherein all wt % values are based on the weight of the entire composition. Compositions of the invention were prepared by replacing a portion of the polycarbonate in the control composition with either PC-siloxane copolymer or boric acid, or both PC-siloxane copolymer and boric acid as noted in the Table. The results for flame resistance tests are shown in Table 5 compared to the control composition without PC-siloxane copolymer or boric acid.

TABLE 5

| | | No. of Drips | | | Char | |
|---|---|---|---|---|---|---|
| | | per total | FOT1 | FOT2 | Yield | |
| | Additive | number of | (avg. | (avg. | (wt %; | Tg |
| Ex. | (wt %) | test parts | seconds) | seconds) | N₂/air) | (° C.) |
| CEx.25 | — | 0/10 | 12.8 | 38.0 | 22.4/0 | 145.1 |
| 25 | PC-siloxane (0.5) | 0/10 | 10.4 | 17.5 | — | — |
| 26 | boric acid (0.38) | 4/10 | 3.0 | 23.7 | — | — |
| 27 | PC-siloxane (0.5) | 0/10 | 11.8 | 13.6 | — | — |
| | boric acid (0.38) | | | | | |
| 28 | PC-siloxane (2.5) | 0/10 | 5.8 | 10.5 | 21.2/0.1 | 146.3 |
| 29 | boric acid (1.92) | 0/10 | 1.1 | 6.6 | 24.6/0.9 | — |
| 30 | PC-siloxane (2.5) | 0/10 | 2.4 | 3.7 | 25.3/2.4 | 142.8 |
| | boric acid (1.92) | | | | | |

The compositions comprising a mixture of both PC-siloxane copolymer and boric acid show improved flame resistance and improved char yield with no significant decrease in Tg for the polycarbonate phase compared to the control composition and the compositions with either PC-siloxane copolymer alone or boric acid alone.

### EXAMPLES 31-38

A base formulation comprised polycarbonate with 4 wt % ABS; 1% of a 50% concentrate of polytetrafluoroethylene in SAN; 0.6 wt % mold release agents and thermal stabilizers, wherein all wt % values are based on the weight of the entire composition. Compositions of the invention were prepared by replacing a portion of the polycarbonate in the base formulation with 2.5 wt % silicone source and 1.1 molar equivalents boron source (based on silicone source or in the case of PC-siloxane copolymer based on siloxane repeat units present). Some of the compositions also comprised bisphenol A diphosphate (BPADP) in amounts as noted in the Table, prepared by replacing a portion of the polycarbonate. Some of the compositions also comprised stabilizers in amounts as noted in the Table, prepared by replacing a portion of the polycarbonate. The results for flame resistance tests, melt flow index tests, and glass transition temperatures are shown in Table 6. Average first and second flame out times (FOT) are given in seconds. Melt flow index (MFI) values were determined at 280° C. using a 1.2 kg. load and are reported in units of grams per 3 minutes.

TABLE 6

| | | | | | FOT1 | FOT2 |
|---|---|---|---|---|---|---|
| | | | | | (avg. | (avg. |
| Example | Boron source | Siloxane source | BPADP | Stabilizer | seconds) | seconds) |
| 31 | boric acid | PC-siloxane | 2 wt % | — | 2.0 | 3.9 |
| 32 | boric acid | PC-siloxane | — | — | 5.0 | 4.5 |
| 33 | boron oxide | PC-siloxane | — | — | 6.7 | 5.4 |
| 34 | boron phosphate | PC-siloxane | — | — | 5.5 | 8.4 |
| 35 | boric acid | Ph₂Si(OH)₂ | — | — | 4.7 | 10.9 |
| 36 | boron oxide | PC-siloxane | 1 wt % | mannitol | 3.7 | 3.9 |
| | | | | (2.8 wt %) | | |
| 37 | boron oxide | PC-siloxane | 1 wt % | pentaerythritol | 2.1 | 4.0 |
| | | | | (2.1 wt %) | | |
| 38 | boron oxide | PC-siloxane | 1 wt % | Ph₂Si(OH)₂ | 1.9 | 4.5 |
| | | | | (3.3 wt %) | | |

The compositions comprising a stabilizer showed acceptable flame out times with no significant decrease in glass transition temperature of the polycarbonate phase. In addition the compositions comprising a stabilizer showed improved surface appearance and MFI values associated improved retention of polycarbonate molecular weight.

### EXAMPLES 39-45 And COMPARATIVE EXAMPLE 39

Compositions were prepared comprising the amounts of polycarbonate (PC), boron source, and silicone source shown in the Table. All compositions also contained 4 wt % ABS, 2 wt % BPADP, and 1% of a 50% concentrate of polytetrafluoroethylene in SAN. All compositions also contained 0.6 wt % of mold release agents and thermal stabilizers which are not believed to affect the flame resistance properties. All wt % values are based on the weight of the entire composition. The results for flame resistance tests are shown in Table 7 compared to a control composition without siloxane source or boron source. The abbreviation “PDMS” means polydimethylsiloxane with viscosity given in centistokes. The abbreviation “Me-co-Ph silicone” means poly(dimethylsiloxane-co-diphenylsiloxane) with viscosity given in centistokes. The compositions were processed by extrusion. Values for splay on molded part surfaces are rated on a subjective scale from 1 to 5 with 5 being virtual absence of splay. “Total Avg. FOT” is the sum of the average of first flame out time and the average of second flame out time.

TABLE 7

| Component | CEx. 39 | Ex. 39 | Ex. 40 | Ex. 41 | Ex. 42 | Ex. 43 | Ex. 44 | Ex. |
|---|---|---|---|---|---|---|---|---|
| PC | 92.4 | 86.45 | 75.76 | 86.45 | 88.66 | 86.45 | 85.75 | 81. |
| PC-siloxane copolymer | | | 13.35 | | | | | 6.6 |
| PDMS/ | | | | | 2.66 | | | |
| OH terminated 25 cSt | | | | | | | | |
| PDMS/ | | | | 2.66 | | | | 1.4 |
| OH terminated 60 cSt | | | | | | | | |
| PDMS/ | | | | | | 2.66 | | |
| OH terminated 750 cSt | | | | | | | | |
| PDMS/ | | 2.66 | | | | | | |
| OMe terminated | | | | | | | | |
| Me-co-Ph silicone/ | | | | | | | 3.36 | |
| dihydroxy terminated | | | | | | | | |
| 60 cSt | | | | | | | | |
| boron oxide | | | | | 1.08 | | | |
| boron phosphate | | 3.29 | 3.29 | 3.29 | | 3.29 | 3.29 | 3.2 |
| Processing | good | poor | good | good | good | good | good | goo |
| Splay | 5 | — | 5 | 3 | 4.5 | 3 | 5 | 5 |
| Total Avg. FOT (sec.) | 21 | — | 7.7 | 6.7 | 3.3 | 8.9 | 6.7 | 7. |

The compositions comprising a mixture of both hydroxy-terminated siloxane source and boron source show good surface properties and improved flame resistance compared to the control composition without siloxane source and boron source. In contrast use of a methoxy-terminated siloxane source resulted in a composition that could not be processed by extrusion.

### EXAMPLES 46-50

Compositions were prepared comprising the amounts of polycarbonate (PC), boron source, and silicone source shown in the Table. All compositions also contained 4 wt % ABS, 2 wt % BPADP, and 1% of a 50% concentrate of polytetrafluoroethylene in SAN. All compositions also contained 0.6 wt % of mold release agents and thermal stabilizers which are not believed to affect the flame resistance properties. Certain compositions also contained stabilizers in amounts as noted in the Table. All wt % values are based on the weight of the entire composition. The results for flame resistance tests are shown in Table 8. The abbreviation “PDMS” means polydimethylsiloxane with viscosity given in centistokes. Melt flow index (MFI) values were determined at 280° C. using a 1.2 kg. load and are reported in units of grams per 3 minutes. “Total Avg. FOT” is the sum of the average of first flame out time and the average of second flame out time. The row titled “Foaming” refers to whether foaming was observed during the MFI test.

TABLE 8

| Component | Ex. 46 | Ex. 47 | Ex. 48 | Ex. 49 | Ex. 50 |
|---|---|---|---|---|---|
| PC | 88.66 | 87.24 | 87.96 | 87.96 | 88.16 |
| PDMS/ | 2.66 | 2.66 | 2.66 | | 2.66 |
| OH terminated 25 cSt | | | | | |
| PDMS/ | | | | 2.66 | |
| OH terminated 60 cSt | | | | | |
| boron oxide | 1.08 | 1.08 | 1.08 | 1.08 | 1.08 |
| mannitol | | 1.42 | 0.7 | 0.7 | |
| pentaerythritol | | | | | 0.5 |
| MFI | 8.1 | 2.84 | 2.03 | 1.81 | 2.15 |
| Foaming | yes | slight | slight | yes | no |
| Total Avg. FOT (sec.) | 3.8 | 6.55 | 7.5 | 4.26 | 5.41 |

The compositions comprising a stabilizer showed acceptable flame out times, MFI values associated improved retention of polycarbonate molecular weight, and less tendency to foam compared to compositions without stabilizer.

### EXAMPLES 51-53 AND COMPARATIVE EXAMPLES 51-52

Compositions were prepared comprising the amounts of polycarbonate (PC), boron source, and silicone source shown in the Table. All compositions also contained 4 wt % ABS, 2 wt % BPADP, and 1% of a 50% concentrate of polytetrafluoroethylene in SAN. All compositions also contained 0.6 wt % of mold release agents and thermal stabilizers which are not believed to affect the flame resistance properties. All wt % values are based on the weight of the entire composition. The results for flame resistance tests are shown in Table 9. The abbreviation “PDMS” means polydimethylsiloxane with viscosity given in centistokes. “Total Avg. FOT” is the sum of the average of first flame out time and second flame out time. The abbreviation “PDMS” means polydimethylsiloxane with viscosity given in centistokes. The compositions were processed by extrusion.

TABLE 9

| Component | Ex. 51 | Ex. 52 | Ex. 53 | CEx. 51 | CEx. 52 |
|---|---|---|---|---|---|
| PC | 88.66 | 89.2 | 89.63 | 89.72 | 89.73 |
| PDMS/ | 2.66 | 2.66 | 2.66 | 2.66 | 2.66 |
| OH terminated 60 | | | | | |
| cSt | | | | | |
| boron oxide | 1.08 | 0.54 | 0.11 | 0.022 | 0.011 |
| FOT1 | 1.13 | 1.18 | 3.89 | 1.76 | — |
| (avg. seconds) | | | | | |
| FOT2 | 2.08 | 3.6 | 6.43 | 9.42 | — |
| (avg. seconds) | | | | | |
| Total Avg. FOT | 3.21 | 4.78 | 10.32 | 11.18 | — |
| (sec.) | | | | | |
| Processing | good | good | rough | rough | could |
| | | | extrudate | extrudate | not |
| | | | strand | strand | extrude |

The compositions comprising a boron source in an amount of greater than 0.1 wt % showed acceptable flame out times and ease of processing compared to compositions comprising less than 0.1 wt % boron source. FIG. 3 shows a graph of FOT2 versus the boron oxide level in the processed compositions of Examples 51-53 and CEx. 51. It can be seen that at constant siloxane level FOT2 decreases with increasing boron oxide level.

### EXAMPLES 54-61

A base formulation comprised polycarbonate with 4 wt % ABS; 1.92 wt % bororic acid; 1% of a 50% concentrate of polytetrafluoroethylene in SAN; and 0.6 wt % mold release agents and thermal stabilizers, wherein all wt % values are based on the weight of the entire composition. Compositions of the invention were prepared by replacing a portion of the polycarbonate in the base formulation with the amounts of silicone source shown in the Table in wt % based on the weight of the entire composition. Some compositions contained as silicone source PC-siloxane copolymers with varying content of polydimethylsiloxane segments in combination with BPA polycarbonate segments. PC-siloxane copolymers in the Table are designated in a format wherein the first number represents the wt % siloxane in the copolymer and the second “D” number represents the approximate number of D units in the initial silicone starting material (e.g. D2, D10, etc.). Other silicone sources included “PDMS LV”, a polydimethylsiloxane with viscosity of about 5 cSt. The results for flame resistance tests are shown in Table 10. Average first and second flame out times (FOT) are given in seconds.

TABLE 10

| | | Amt. siloxane | | |
|---|---|---|---|---|
| Example | Silicone source | source (wt %) | FOT1 | FOT2 |
| 54 | 5D2 | 50 | 3.0 | 11.9 |
| 55 | 3D10 | 83.3 | 2.1 | 6.9 |
| 56 | 3D20 | 83.3 | 4.2 | 7.7 |
| 57 | 20D50 | 12.5 | 4.8 | 8.8 |
| 58 | 36D50 | 6.94 | 5.2 | 8.4 |
| 59 | PDMS LV | 2.5 | 4.7 | 4.5 |
| 60 | Ph₂Si(OH)₂ | 7.29 | 4.7 | 10.9 |
| 61 | Octaphenylcyclotetrasiloxane | 6.69 | 1.7 | 8.2 |

The data show that various silicone sources in combination with a boron source provide adequate FOT values in polycarbonate-comprising compositions.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents cited herein are incorporated herein by reference.

1. A flame retardant resinous composition comprising
(i) at least one aromatic polycarbonate,
(ii) at least one silicone source,
(iii) at least one boron source, and
(iv) optionally at least one member selected from the group consisting of an antidrip agent, a second thermoplastic resin which is not a polycarbonate resin, and a rubber modified graft copolymer.

2. The composition of claim 1 wherein the aromatic polycarbonate comprises structural units derived from at least one dihydric phenol selected from the group consisting of 6-hydroxy-1-(4′-hydroxyphenyl)-1,3,3-trimethylindane, 4,4′-(3,3,5-trimethylcyclohexylidene)diphenol; 1,1-bis(4-hydroxy-3-methylphenyl)cyclohexane; 2,2-bis(4-hydroxyphenyl)propane; 4,4-bis(4-hydroxyphenyl)heptane; 2,2-bis(4-hydroxy-3,5-dimethylphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,4′-dihydroxydiphenylmethane; bis(2-hydroxyphenyl)methane; bis(4-hydroxy-phenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(3-phenyl-4-hydroxyphenyl)-propane; bis(4-hydroxyphenyl)cyclohexylmethane; 2,2-bis(4-hydroxyphenyl)-1-phenylpropane; 3,5,3′,5′-tetrachloro-4,4′-dihydroxyphenyl)propane; 2,4′-dihydroxyphenyl sulfone; 2,6-dihydroxy naphthalene; 6,6′-dihydroxy-3,3,3′,3′-tetramethyl-1,1′-spirobiindane; hydroquinone, resorcinol; C₁₋₃ alkyl-substituted resorcinols; 3-(4-hydroxyphenyl)-1,1,3-trimethylindan-5-ol, and 1-(4-hydroxyphenyl)-1,3,3-trimethylindan-5-ol.

3. The composition of claim 2 wherein the dihydric phenol comprises bisphenol A.

4. The composition of claim 1 wherein the silicone source comprises at least one member selected from the group consisting of a copolymer comprising siloxane structural units in combination with structural units from a second, non-silicon-containing polymer; a hydroxy-terminated poly(diorganosiloxane); and a non-polymeric molecule with molecular weight less than about 500 comprising at least one silicon atom, at least one aromatic moiety, and at least one hydroxy group.

5. The composition of claim 4 wherein the silicone source comprises a copolymer with structural units of polydimethylsiloxane in combination with structural units of bisphenol A polycarbonate.

6. The composition of claim 4 wherein the silicone source is a hydroxy-terminated polymer comprising poly(dimethylsiloxane) structural units.

7. The composition of claim 4 wherein the silicone source is present in an amount in a range of between about 0.1 wt % and about 10 wt %, based on the weight of the entire composition.

8. The composition of claim 1 wherein the boron source is at least one member selected from the group consisting of boric acid, boron oxide, and boron phosphate.

9. The composition of claim 8 wherein the boron source is present in an amount in a range of between about 0.1 wt % and about 10 wt %, based on the weight of the entire composition.

10. The composition of claim 1 further comprising at least one antidrip agent.

11. The composition of claim 10 wherein the antidrip agent comprises at least one fluoropolymer.

12. The composition of claim 11 wherein the fluoropolymer is present in an amount in a range of between about 0.01 wt % and about 2 wt %, based on the weight of the entire composition.

13. The composition of claim 11 wherein the fluoropolymer comprises polytetrafluoroethylene.

14. The composition of claim 11 wherein the fluoropolymer is added to the composition in the form of a concentrate in at least one other resinous component of the composition.

15. The composition of claim 1 further comprising at least one of a second thermoplastic resin, which is not a polycarbonate resin and which exhibits a Tg of greater than about 25° C.

16. The composition of claim 15 wherein the second thermoplastic resin comprises structural units derived from one or more monomers selected from the group consisting of vinyl aromatic monomers, monoethylenically unsaturated nitrile monomers, and C₁-C₁₂ alkyl (meth)acrylate monomers.

17. The composition of claim 16 wherein the second thermoplastic resin comprises structural units derived from styrene and acrylonitrile.

18. The composition of claim 15 wherein the second thermoplastic resin is present in an amount in a range of between about 0.1 wt % and about 35 wt %, based on the weight of the entire composition.

19. The composition of claim 1 further comprising at least one rubber modified graft copolymer comprising a discontinuous rubber phase dispersed in a continuous rigid thermoplastic phase, wherein at least a portion of the rigid thermoplastic phase is chemically grafted to the rubber phase.

20. The composition of claim 19 wherein the rubber phase has a glass transition temperature of less than or equal to 25° C.

21. The composition of claim 20 wherein the rubber comprises structural units derived from at least one of 1,3-butadiene, isoprene, or butyl acrylate.

22. The composition of claim 19 wherein the rigid thermoplastic resin has a glass transition temperature of greater than about 25° C., and from about 10 to about 90 wt % of the rigid thermoplastic phase is chemically grafted to the rubber phase.

23. The composition of claim 19 wherein the rubber phase comprises a polybutadiene rubber, poly(styrene-butadiene) rubber, poly(butyl acrylate) rubber, or ethylene-propylene-diene modified rubber, and the rigid thermoplastic phase comprises a styrene-acrylonitrile copolymer.

24. The composition of claim 19 wherein the rubber modified graft copolymer is present in an amount in a range of between about 0.1 wt % and about 35 wt %, based on the weight of the entire composition.

25. The composition of claim 1 further comprising at least one of a second thermoplastic resin and at least one rubber modified graft copolymer,
wherein the second thermoplastic resin exhibits a T_{g} of greater than about 25° C. and is not a polycarbonate resin; and
wherein the rubber modified graft copolymer comprises a discontinuous rubber phase dispersed in a continuous rigid thermoplastic phase,
wherein at least a portion of the rigid thermoplastic phase is chemically grafted to the rubber phase.

26. The composition of claim 25 wherein the second thermoplastic resin comprises structural units derived from styrene and acrylonitrile; and the rubber modified graft copolymer rubber phase comprises a polybutadiene or poly(styrene-butadiene) rubber and the rigid thermoplastic phase comprises a styrene-acrylonitrile copolymer.

27. The composition of claim 1 further comprising at least one polyfunctional alcohol comprising at least two hydroxy groups.

28. The composition of claim 27 wherein the polyfunctional alcohol is selected from the group consisting of mannitol, sorbitol, fructose, glucose, pentaerythritol, cyclodextrin, sucrose, galactose, maltose, ribose, and xylitol.

29. The composition of claim 27 wherein the polyfunctional alcohol is present in an amount in a range of between about 0.1 wt % and about 10 wt %, based on the weight of the entire composition.

30. The composition of claim 1 further comprising at least one polymeric or non-polymeric organic phosphorus species selected from the group consisting of phosphate esters, thiophosphate esters, phosphonate esters, thiophosphonate esters, phosphinate esters, thiophosphinate esters, phosphines, triphenylphosphine, phosphine oxides, triphenylphosphine oxide, tris(2-cyanoethyl)phosphine oxide, thiophosphine oxides, and phosphonium salts.

31. The composition of claim 30 wherein the phosphorus species is an aromatic phosphate.

32. The composition of claim 31 wherein the aromatic phosphate is selected from the group consisting of triphenylphosphate, tricresylphosphate, resorcinol bis(diphenylphosphate), and bisphenol A bis(diphenylphosphate).

33. The composition of claim 30 wherein the phosphorus species is present in an amount in a range of between about 0.5 wt % and about 15 wt %, based on the weight of the entire composition.

34. A flame retardant resinous composition comprising:
(v) a bisphenol A polycarbonate present in an amount in a range of between about 88 wt % and about 98 wt %;
(vi) at least one silicone source present in an amount in a range of between about 0.4 wt % and about 3 wt %; and selected from the group consisting of a copolymer comprising polydimethylsiloxane structural units in combination with bisphenol A polycarbonate structural units; and a hydroxy-terminated poly(dimethylsiloxane); and
(vii) at least one boron source present in an amount in a range of between about 0.2 wt % and about 2 wt %; and selected from the group consisting of boric acid, boron oxide, and boron phosphate;
wherein all amounts are based on the weight of the entire composition.

35. The composition of claim 34 further comprising polytetrafluoroethylene present in an amount in a range of between about 0.1 wt % and about 1 wt %, based on the weight of the entire composition.

36. A flame retardant resinous composition comprising:
(viii) a bisphenol A polycarbonate present in an amount in a range of between about 65 wt % and about 84 wt %;
(ix) a styrene-acrylonitrile copolymer present in an amount in a range of between about 10 wt % and about 18 wt %;
(x) at least one silicone source present in an amount in a range of between about 0.4 wt % and about 3 wt %; and selected from the group consisting of a copolymer comprising polydimethylsiloxane structural units in combination with bisphenol A polycarbonate structural units; and a hydroxy-terminated poly(dimethylsiloxane); and
(xi) at least one boron source present in an amount in a range of between about 0.2 wt % and about 2 wt %; and selected from the group consisting of boric acid, boron oxide, and boron phosphate;
wherein all amounts are based on the weight of the entire composition.

37. The composition of claim 36 further comprising polytetrafluoroethylene present in an amount in a range of between about 0.1 wt % and about 1 wt %, based on the weight of the entire composition.

38. The composition of claim 36 further comprising at least one polyfunctional alcohol present in an amount in a range of between about 0.5 wt % and about 3.5 wt %, based on the weight of the entire composition, and selected from the group consisting of mannitol, sorbitol, fructose, and pentaerythritol.

39. The composition of claim 36 further comprising
(a) polytetrafluoroethylene present in an amount in a range of between about 0.1 wt % and about 1 wt %, based on the weight of the entire composition; and
(b) at least one polyfunctional alcohol present in an amount in a range of between about 0.5 wt % and about 3.5 wt %, based on the weight of the entire composition, and selected from the group consisting of mannitol, sorbitol, fructose, and pentaerythritol.

40. A flame retardant resinous composition comprising:
(xii) a bisphenol A polycarbonate present in an amount in a range of between about 65 wt % and about 84 wt %;
(xiii) a rubber modified graft copolymer present in an amount in a range of between about 2 wt % and about 14 wt %, and comprising a polybutadiene or poly(styrene-butadiene) rubber, and a styrene-acrylonitrile copolymer;
(xiv) at least one silicone source present in an amount in a range of between about 0.4 wt % and about 3 wt %; and selected from the group consisting of a copolymer comprising polydimethylsiloxane structural units in combination with bisphenol A polycarbonate structural units; and a hydroxy-terminated poly(dimethylsiloxane); and
(xv) at least one boron source present in an amount in a range of between about 0.2 wt % and about 2 wt %; and selected from the group consisting of boric acid, boron oxide, and boron phosphate;
wherein all amounts are based on the weight of the entire composition.

41. The composition of claim 40 further comprising polytetrafluoroethylene present in an amount in a range of between about 0.1 wt % and about 1 wt %, based on the weight of the entire composition.

42. The composition of claim 40 further comprising at least one polyfunctional alcohol present in an amount in a range of between about 0.5 wt % and about 3.5 wt %, based on the weight of the entire composition, and selected from the group consisting of mannitol, sorbitol, fructose, and pentaerythritol.

43. The composition of claim 40 further comprising at least one aromatic phosphate present in an amount in a range of between about 2 wt % and about 6 wt %, based on the weight of the entire composition, and selected from the group consisting of triphenylphosphate, tricresylphosphate, resorcinol bis(diphenylphosphate), and bisphenol A bis(diphenylphosphate).

44. The composition of claim 40 further comprising both of at least one polyfunctional alcohol present in an amount in a range of between about 0.5 wt % and about 3.5 wt %, based on the weight of the entire composition, and selected from the group consisting of mannitol, sorbitol, fructose, and pentaerythritol; and
at least one aromatic phosphate present in an amount in a range of between about 2 wt % and about 6 wt %, based on the weight of the entire composition, and selected from the group consisting of triphenylphosphate, tricresylphosphate, resorcinol bis(diphenylphosphate), and bisphenol A bis(diphenylphosphate).

45. A flame retardant resinous composition comprising:
(xvi) a bisphenol A polycarbonate present in an amount in a range of between about 65 wt % and about 84 wt %;
(xvii) a styrene-acrylonitrile copolymer present in an amount in a range of between about 10 wt % and about 18 wt %;
(xviii) a rubber modified graft copolymer present in an amount in a range of between about 2 wt % and about 14 wt %, and comprising a polybutadiene or poly(styrene-butadiene) rubber, and a styrene-acrylonitrile copolymer;
(xix) at least one silicone source present in an amount in a range of between about 0.4 wt % and about 3 wt %; and selected from the group consisting of a copolymer comprising polydimethylsiloxane structural units in combination with bisphenol A polycarbonate structural units; and a hydroxy-terminated poly(dimethylsiloxane); and
(xx) at least one boron source present in an amount in a range of between about 0.2 wt % and about 2 wt %; and selected from the group consisting of boric acid, boron oxide, and boron phosphate;
wherein all amounts are based on the weight of the entire composition.

46. The composition of claim 45 further comprising polytetrafluoroethylene present in an amount in a range of between about 0.1 wt % and about 1 wt %, based on the weight of the entire composition.

47. The composition of claim 45 further comprising at least one polyfunctional alcohol in an amount in a range of between about 0.5 wt % and about 3.5 wt %, based on the weight of the entire composition, and selected from the group consisting of mannitol, sorbitol, fructose, and pentaerythritol.

48. The composition of claim 45 further comprising at least one aromatic phosphate present in an amount in a range of between about 2 wt % and about 6 wt %, based on the weight of the entire composition, and selected from the group consisting of triphenylphosphate, tricresylphosphate, resorcinol bis(diphenylphosphate), and bisphenol A bis(diphenylphosphate).

49. The composition of claim 45 further comprising both of at least one polyfunctional alcohol present in an amount in a range of between about 0.5 wt % and about 3.5 wt %, based on the weight of the entire composition, and selected from the group consisting of mannitol, sorbitol, fructose, and pentaerythritol; and
at least one aromatic phosphate present in an amount in a range of between about 2 wt % and about 6 wt %, based on the weight of the entire composition, and selected from the group consisting of triphenylphosphate, tricresylphosphate, resorcinol bis(diphenylphosphate), and bisphenol A bis(diphenylphosphate).

50. A method for making a flame retardant resinous composition comprising:
(i) at least one aromatic polycarbonate,
(ii) at least one silicone source,
(iii) at least one boron source, and
(iv) optionally at least one member selected from the group consisting of an antidrip agent, a second thermoplastic resin which is not a polycarbonate resin, and a rubber modified graft copolymer;
which comprises combining and mixing the components of the composition under conditions suitable for the formation of a blend of the components, and, optionally, then reducing the composition so formed to particulate form.

51. The method of claim 50 wherein the aromatic polycarbonate comprises structural units derived from at least one dihydric phenol selected from the group consisting of 6-hydroxy-1-(4′-hydroxyphenyl)-1,3,3-trimethylindane, 4,4′-(3,3,5-trimethylcyclohexylidene)diphenol; 1,1-bis(4-hydroxy-3-methylphenyl)cyclohexane; 2,2-bis(4-hydroxyphenyl)propane; 4,4-bis(4-hydroxyphenyl)heptane; 2,2-bis(4-hydroxy-3,5-dimethylphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,4′-dihydroxydiphenylmethane; bis(2-hydroxyphenyl)methane; bis(4-hydroxy-phenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(3-phenyl-4-hydroxyphenyl)-propane; bis(4-hydroxyphenyl)cyclohexylmethane; 2,2-bis(4-hydroxyphenyl)-1-phenylpropane; 3,5,3′,5′-tetrachloro-4,4′-dihydroxyphenyl)propane; 2,4′-dihydroxyphenyl sulfone; 2,6-dihydroxy naphthalene; 6,6′-dihydroxy-3,3,3′,3′-tetramethyl-1,1′-spirobiindane; hydroquinone, resorcinol; C-3 alkyl-substituted resorcinols; 3-(4-hydroxyphenyl)-1,1,3-trimethylindan-5-ol, and 1-(4-hydroxyphenyl)-1,3,3-trimethylindan-5-ol.

52. The method of claim 51 wherein the dihydric phenol comprises bisphenol A.

53. The method of claim 50 wherein the silicone source comprises at least one member selected from the group consisting of a copolymer comprising siloxane structural units in combination with structural units from a second, non-silicon-containing polymer; a hydroxy-terminated poly(diorganosiloxane); and a non-polymeric molecule with molecular weight less than about 500 comprising at least one silicon atom, at least one aromatic moiety, and at least one hydroxy group.

54. The method of claim 53 wherein the silicone source comprises a copolymer with structural units of polydimethylsiloxane in combination with structural units of bisphenol A polycarbonate.

55. The method of claim 53 wherein the silicone source is a hydroxy-terminated polymer comprising poly(dimethylsiloxane) structural units.

56. The method of claim 53 wherein the silicone source is present in an amount in a range of between about 0.1 wt % and about 10 wt %, based on the weight of the entire composition.

57. The method of claim 50 wherein the boron source is at least one member selected from the group consisting of boric acid, boron oxide, and boron phosphate.

58. The method of claim 57 wherein the boron source is present in an amount in a range of between about 0.1 wt % and about 10 wt %, based on the weight of the entire composition.

59. The method of claim 50 further comprising at least one antidrip agent.

60. The method of claim 59 wherein the antidrip agent comprises at least one fluoropolymer.

61. The method of claim 60 wherein the fluoropolymer is present in an amount in a range of between about 0.01 wt % and about 2 wt %, based on the weight of the entire composition.

62. The method of claim 58 wherein the fluoropolymer comprises polytetrafluoroethylene.

63. The method of claim 58 wherein the fluoropolymer is added to the composition in the form of a concentrate in at least one other resinous component of the composition.

64. The method of claim 50 further comprising at least one of a second thermoplastic resin, which is not a polycarbonate resin and which exhibits a Tg of greater than about 25° C.

65. The method of claim 64 wherein the second thermoplastic resin comprises structural units derived from one or more monomers selected from the group consisting of vinyl aromatic monomers, monoethylenically unsaturated nitrile monomers, and C₁-C₁₂ alkyl (meth)acrylate monomers.

66. The method of claim 65 wherein the second thermoplastic resin comprises structural units derived from styrene and acrylonitrile.

67. The method of claim 64 wherein the second thermoplastic resin is present in an amount in a range of between about 0.1 wt % and about 35 wt %, based on the weight of the entire composition.

68. The method of claim 50 further comprising at least one rubber modified graft copolymer comprising a discontinuous rubber phase dispersed in a continuous rigid thermoplastic phase, wherein at least a portion of the rigid thermoplastic phase is chemically grafted to the rubber phase.

69. The method of claim 68 wherein the rubber phase has a glass transition temperature of less than or equal to 25° C.

70. The method of claim 69 wherein the rubber comprises structural units derived from at least one of 1,3-butadiene, isoprene, or butyl acrylate.

71. The method of claim 68 wherein the rigid thermoplastic resin has a glass transition temperature of greater than about 25° C., and from about 10 to about 90 wt % of the rigid thermoplastic phase is chemically grafted to the rubber phase.

72. The method of claim 68 wherein the rubber phase comprises a polybutadiene rubber, poly(styrene-butadiene) rubber, poly(butyl acrylate) rubber, or ethylene-propylene-diene modified rubber, and the rigid thermoplastic phase comprises a styrene-acrylonitrile copolymer.

73. The method of claim 68 wherein the rubber modified graft copolymer is present in an amount in a range of between about 0.1 wt % and about 35 wt %, based on the weight of the entire composition.

74. The method of claim 50 further comprising at least one of a second thermoplastic resin and at least one rubber modified graft copolymer,
wherein the second thermoplastic resin exhibits a Tg of greater than about 25° C. and is not a polycarbonate resin; and
wherein the rubber modified graft copolymer comprises a discontinuous rubber phase dispersed in a continuous rigid thermoplastic phase, wherein at least a portion of the rigid thermoplastic phase is chemically grafted to the rubber phase.

75. The method of claim 74 wherein the second thermoplastic resin comprises structural units derived from styrene and acrylonitrile; and the rubber modified graft copolymer rubber phase comprises a polybutadiene or poly(styrene-butadiene) rubber and the rigid thermoplastic phase comprises a styrene-acrylonitrile copolymer.

76. The method of claim 50 further comprising at least one polyfunctional alcohol comprising at least two hydroxy groups.

77. The method of claim 76 wherein the polyfunctional alcohol is selected from the group consisting of mannitol, sorbitol, fructose, glucose, pentaerythritol, cyclodextrin, sucrose, galactose, maltose, ribose, and xylitol.

78. The method of claim 76 wherein the polyfunctional alcohol is present in an amount in a range of between about 0.1 wt % and about 10 wt %, based on the weight of the entire composition.

79. The method of claim 50 further comprising at least one polymeric or non-polymeric organic phosphorus species selected from the group consisting of phosphate esters, thiophosphate esters, phosphonate esters, thiophosphonate esters, phosphinate esters, thiophosphinate esters, phosphines, triphenylphosphine, phosphine oxides, triphenylphosphine oxide, tris(2-cyanoethyl)phosphine oxide, thiophosphine oxides, and phosphonium salts.

80. The method of claim 79 wherein the phosphorus species is an aromatic phosphate.

81. The method of claim 80 wherein the aromatic phosphate is selected from the group consisting of triphenylphosphate, tricresylphosphate, resorcinol bis(diphenylphosphate), and bisphenol A bis(diphenylphosphate).

82. The method of claim 79 wherein the phosphorus species is present in an amount in a range of between about 0.5 wt % and about 15 wt %, based on the weight of the entire composition.

83. A method for making a flame retardant resinous composition comprising:
(v) a bisphenol A polycarbonate present in an amount in a range of between about 88 wt % and about 98 wt %;
(vi) at least one silicone source present in an amount in a range of between about 0.4 wt % and about 3 wt %; and selected from the group consisting of a copolymer comprising polydimethylsiloxane structural units in combination with bisphenol A polycarbonate structural units; and a hydroxy-terminated poly(dimethylsiloxane); and
(vii) at least one boron source present in an amount in a range of between about 0.2 wt % and about 2 wt %; and selected from the group consisting of boric acid, boron oxide, and boron phosphate, wherein all amounts are based on the weight of the entire composition;
which comprises combining and mixing the components of the composition under conditions suitable for the formation of a blend of the components, and, optionally, then reducing the composition so formed to particulate form.

84. The method of claim 83 further comprising polytetrafluoroethylene present in an amount in a range of between about 0.1 wt % and about 1 wt %, based on the weight of the entire composition.

85. A method for making a flame retardant resinous composition comprising
(viii) a bisphenol A polycarbonate present in an amount in a range of between about 65 wt % and about 84 wt %;
(ix) a styrene-acrylonitrile copolymer present in an amount in a range of between about 10 wt % and about 18 wt %;
(x) at least one silicone source present in an amount in a range of between about 0.4 wt % and about 3 wt %; and selected from the group consisting of a copolymer comprising polydimethylsiloxane structural units in combination with bisphenol A polycarbonate structural units; and a hydroxy-terminated poly(dimethylsiloxane); and
(xi) at least one boron source present in an amount in a range of between about 0.2 wt % and about 2 wt %; and selected from the group consisting of boric acid, boron oxide, and boron phosphate, wherein all amounts are based on the weight of the entire composition;
which comprises combining and mixing the components of the composition under conditions suitable for the formation of a blend of the components, and, optionally, then reducing the composition so formed to particulate form.

86. The method of claim 85 further comprising polytetrafluoroethylene present in an amount in a range of between about 0.1 wt % and about 1 wt %, based on the weight of the entire composition.

87. The method of claim 85 further comprising at least one polyfunctional alcohol present in an amount in a range of between about 0.5 wt % and about 3.5 wt %, based on the weight of the entire composition, and selected from the group consisting of mannitol, sorbitol, fructose, and pentaerythritol.

88. The method of claim 85 further comprising
(a) polytetrafluoroethylene present in an amount in a range of between about 0.1 wt % and about 1 wt %, based on the weight of the entire composition; and
(b) at least one polyfunctional alcohol present in an amount in a range of between about 0.5 wt % and about 3.5 wt %, based on the weight of the entire composition, and selected from the group consisting of mannitol, sorbitol, fructose, and pentaerythritol.

89. A method for making a flame retardant resinous composition comprising:
(xii) a bisphenol A polycarbonate present in an amount in a range of between about 65 wt % and about 84 wt %;
(xiii) a rubber modified graft copolymer present in an amount in a range of between about 2 wt % and about 14 wt %, and comprising a polybutadiene or poly(styrene-butadiene) rubber, and a styrene-acrylonitrile copolymer;
(xiv) at least one silicone source present in an amount in a range of between about 0.4 wt % and about 3 wt %; and selected from the group consisting of a copolymer comprising polydimethylsiloxane structural units in combination with bisphenol A polycarbonate structural units; and a hydroxy-terminated poly(dimethylsiloxane); and
(xv) at least one boron source present in an amount in a range of between about 0.2 wt % and about 2 wt %; and selected from the group consisting of boric acid, boron oxide, and boron phosphate, wherein all amounts are based on the weight of the entire composition;
which comprises combining and mixing the components of the composition under conditions suitable for the formation of a blend of the components, and, optionally, then reducing the composition so formed to particulate form.

90. The method of claim 89 further comprising polytetrafluoroethylene present in an amount in a range of between about 0.1 wt % and about 1 wt %, based on the weight of the entire composition.

91. The method of claim 89 further comprising at least one polyfunctional alcohol present in an amount in a range of between about 0.5 wt % and about 3.5 wt %, based on the weight of the entire composition, and selected from the group consisting of mannitol, sorbitol, fructose, and pentaerythritol.

92. The method of claim 89 further comprising at least one aromatic phosphate present in an amount in a range of between about 2 wt % and about 6 wt %, based on the weight of the entire composition, and selected from the group consisting of triphenylphosphate, tricresylphosphate, resorcinol bis(diphenylphosphate), and bisphenol A bis(diphenylphosphate).

93. The method of claim 89 further comprising both of at least one polyfunctional alcohol present in an amount in a range of between about 0.5 wt % and about 3.5 wt %, based on the weight of the entire composition, and selected from the group consisting of mannitol, sorbitol, fructose, and pentaerythritol; and
at least one aromatic phosphate present in an amount in a range of between about 2 wt % and about 6 wt %, based on the weight of the entire composition, and selected from the group consisting of triphenylphosphate, tricresylphosphate, resorcinol bis(diphenylphosphate), and bisphenol A bis(diphenylphosphate).

94. A method for making a flame retardant resinous composition comprising:
(xvi) a bisphenol A polycarbonate present in an amount in a range of between about 65 wt % and about 84 wt %;
(xvii) a styrene-acrylonitrile copolymer present in an amount in a range of between about 10 wt % and about 18 wt %;
(xviii) a rubber modified graft copolymer present in an amount in a range of between about 2 wt % and about 14 wt %, and comprising a polybutadiene or poly(styrene-butadiene) rubber, and a styrene-acrylonitrile copolymer;
(xix) at least one silicone source present in an amount in a range of between about 0.4 wt % and about 3 wt %; and selected from the group consisting of a copolymer comprising polydimethylsiloxane structural units in combination with bisphenol A polycarbonate structural units; and a hydroxy-terminated poly(dimethylsiloxane); and
(xx) at least one boron source present in an amount in a range of between about 0.2 wt % and about 2 wt %; and selected from the group consisting of boric acid, boron oxide, and boron phosphate, wherein all amounts are based on the weight of the entire composition;
which comprises combining and mixing the components of the composition under conditions suitable for the formation of a blend of the components, and, optionally, then reducing the composition so formed to particulate form.

95. The method of claim 94 further comprising polytetrafluoroethylene present in an amount in a range of between about 0.1 wt % and about 1 wt %, based on the weight of the entire composition.

96. The method of claim 94 further comprising at least one polyfunctional alcohol in an amount in a range of between about 0.5 wt % and about 3.5 wt %, based on the weight of the entire composition, and selected from the group consisting of mannitol, sorbitol, fructose, and pentaerythritol.

97. The method of claim 94 further comprising at least one aromatic phosphate present in an amount in a range of between about 2 wt % and about 6 wt %, based on the weight of the entire composition, and selected from the group consisting of triphenylphosphate, tricresylphosphate, resorcinol bis(diphenylphosphate), and bisphenol A bis(diphenylphosphate).

98. The method of claim 94 further comprising both of at least one polyfunctional alcohol present in an amount in a range of between about 0.5 wt % and about 3.5 wt %, based on the weight of the entire composition, and selected from the group consisting of mannitol, sorbitol, fructose, and pentaerythritol; and
at least one aromatic phosphate present in an amount in a range of between about 2 wt % and about 6 wt %, based on the weight of the entire composition, and selected from the group consisting of triphenylphosphate, tricresylphosphate, resorcinol bis(diphenylphosphate), and bisphenol A bis(diphenylphosphate).
